(19) United States
(12) Patent Application Publication
(10) Pub. No.: US 2010/0273902 A1
(43) Pub. Date: Oct. 28, 2010

(54) DURABLE CONCRETE COMPOSITIONS

(75) Inventors: Tricia G Ladely, Beaver, PA (US); Blain Hileman, New Castle, PA (US); Kristen Van Buskirk, Aliquippa, PA (US); Rick Hughes, Beaver, PA (US); Jiansheng Tang, Westfield, IN (US); Daniel Woolfsmith, Bridgeville, PA (US)

Correspondence Address: NOVA Chemicals Inc./Karen S. Lockhart, 1555 Coraopolis Heights Road, Moon Township, PA, 15108, US

(73) Assignee: NOVA CHEMICALS INC., Moon Township, PA (US)

(21) Appl. No.: 12/830,637

(22) Filed: Jul. 6, 2010

Related U.S. Application Data
(63) Continuation of application No. 12/110,417, filed on Apr. 28, 2008, now abandoned.
Application No. 12/110,417 is a continuation-in-part of application No. 12/612,097, filed on Nov. 4, 2009.
Application No. 12/612,097 is a division of application No. 11/387,198, filed on Mar. 22, 2006, now Pat. No. 7,644,548.
(60) Provisional application No. 60/927,565, filed on May 4, 2007.
(60) Provisional application No. 60/932,547, filed on May 31, 2007.
(60) Provisional application No. 60/962,308, filed on Jul. 27, 2007.
(60) Provisional application No. 60/664,230, filed on Mar. 22, 2005.
(60) Provisional application No. 60/686,858, filed on Jun. 2, 2005.

(51) Int. Cl. C04B 24/26

(52) U.S. Cl. 521/55

(57) ABSTRACT

Methods of controlling the durability of and/or the amount of air in concrete formulations that include combining cement, water, and optionally aggregates, admixtures and/or additives to form a cement mixture; and adding prepuff particles to the cement mixture to form a concrete formulation. The prepuff particles have an average particle diameter of from 0.2 mm to 3 mm, a bulk density of from 0.015 g/cc to 0.35 g/cc, an aspect ratio of from 1 to 3, and a smooth continuous outer surface. The cured and hardened concrete formulation typically has a relative dynamic modulus of at least 70% determined according to Procedure A of ASTM C666 (2003). The amount of air in the concrete typically increases over the amount of air in similar formulations not containing prepuff particles, as determined according to ASTM C231, based on the volume percent of prepuff. The concrete formulations can be used to make articles.

### REFERENCE TO RELATED APPLICATION

This application claims the benefit of priority of U.S. Provisional Application Ser. Nos. 60/927,565 filed May 4, 2007 entitled “Controlling Air in Concrete Compositions,” 60/932,547 filed May 31, 2007 entitled “Controlling Air in Concrete Compositions,” and 60/962,308 filed Jul. 27, 2007 entitled “Controlling Air in Concrete Compositions,” which are all herein incorporated by reference in their entirety.

### BACKGROUND OF THE INVENTION

1. Field of the Invention

The present invention is directed to novel compositions, materials, methods of their use and methods of their manufacture that are generally useful as agents in the construction and building trades. More specifically, the methods and compositions of the present invention can be used in construction and building applications that benefit from a relatively lightweight, extendable, moldable, pourable, material that has high strength and improved durability properties.

2. Description of the Prior Art

Concrete, like all porous media, has the ability to retain and absorb moisture. Under freezing conditions, ice can grow within the concrete pores, leading to significant internal cracking of the cement matrix and/or scaling of the concrete surface. While the precise mechanisms of frost action are not known, concrete deterioration is believed to result from three important forces: crystallization, hydraulic and diffusion/osmotic pressures. These mechanisms are thought to produce flows of metastable water in the concrete pores that generate sufficiently high stresses to induce fracture of the cement matrix. To reduce the internal pressures, air-entrained voids are often placed within the cement matrix to provide escape boundaries for the flow of unstable water.

The best-known technique to prevent or reduce the damage done through freezing and thawing cycles is to incorporate microscopically fine pores or voids into the concrete composition. The pores or voids function as internal expansion chambers and can protect the concrete from frost damage by relieving the hydraulic pressure caused by an advancing freezing front in the concrete. A typical method used to artificially produce such voids in concrete has been the incorporation of air-entraining agents, which stabilize tiny bubbles of air that are entrained in the concrete during mixing. The air voids are typically stabilized by use of surfactants during the mixing process of concrete.

Experience has shown that properly air-entrained concrete samples provide consistently good results in terms of the ASTM C 666 standard freeze-thaw tests. However, in practice, the technique of air entrainment has several disadvantages such as inconsistencies in spacing factors, i.e., the distance between voids and uncertainties in bubble stability. Both issues have caused frequent discrepancies between expected and actual frost durability.

For example, air voids in wet concrete do not always survive during transportation, pouring, casting and/or finishing. When air voids are lost in this manner, the durability of the final concrete is less, in many cases much less, than the durability would be without the loss of air voids.

It is generally accepted in the art that the air void characteristics of concrete systems that demonstrate good durability have an average maximum distance between air voids of less than 0.008 inches (0.2 mm), which is often referred to as the “spacing factor” and a “specific surface area” (average surface area of the air voids) of at least 600 in² per cubic inch (23.6 mm²/mm³). Further, the number of voids per linear inch (25 mm) of traverse is typically greater than the numerical value of the percentage of air in the concrete.

Thus, controlled and defined air content in concrete is a necessary component for concrete durability. The air content in concrete is primarily present in two ways, entrapped air and entrained air. Entrapped air is present as bubbles of various size, the natural result of mixing. Since mixing processes are not perfectly reproducible, entrapped air is typically present as random large air voids or air pockets in the concrete. These large random voids act as weak spots in concrete. Generally, less than two percent of the total air content within a batch of concrete is entrapped air.

In contrast, entrained air is often considered to be “good air”. Chemical admixtures are often employed to entrain small (0.05-1.0 mm) air bubbles that are numerous in number and evenly dispersed in the concrete. Entrained air has been found to aid in the expansion and contraction process during freeze-thaw cycles, allowing pressures to escape to the entrained air voids instead of exerting force on the concrete as described above.

The purpose of an air-entrainment agent is not to entrap air bubbles, which happens as a result of imperfect mixing, but to stabilize bubbles having particular properties in the cement matrix. The role of the air-entrainment molecules is to stabilize the air-water interface, reduce the surface tension of water, and to bind the air bubbles to the cement particles. Typical air-entrainment compounds are aqueous solutions of ionic or nonionic surfactants. Air-entrainment molecules stabilize air bubbles by adsorbing at the air/water interface with their hydrophobic ends protruding into the air-void itself and their hydrophilic ends remaining in the aqueous phase.

Commercial air-entrainment products are typically dilute aqueous solutions (5% to 20% by weight) of surfactants. In practice, there are five basic groups of surfactants suitable for concrete use (a) abietic and pimeric acids salts (neutralized wood resins), (b) fatty acid salts, (c) alkyl-aryl sulphonates, (d) alkyl sulphates, and (e) phenol ethoxylates.

The high carbon content in certain fly ash products can absorb conventional air entraining admixtures, reducing the amount of air produced in the concrete. The amount of air entrained in the concrete controls the freeze-thaw durability, and low levels of entrained air make the concrete susceptible to frost damage. Carbon content in fly ash is expressed as loss on ignition (LOI) determined according to ASTM C 618. An LOI value above 5% or 6% is considered high. Typically, when high LOI fly ash is used in concrete, the freeze-thaw durability of the concrete is not acceptable.

Unfortunately, these approaches of entraining air voids in concrete are plagued by a number of production and placement issues as well, a non-limiting list of which include air content, air void stabilization, air void characteristics, and over finishing.

Changes in air content of the concrete composition can result in concrete with poor resistance to freezing and thawing distress if the air content drops with time or reduce the compressive strength of concrete if the air content increases with time. Examples include pumping concrete (decrease air content by compression), job-site addition of a superplasticizer (often elevates air content or destabilizes the air void system), and interaction of specific admixtures with the air-entraining surfactant (could increase or decrease air content).

The inability to stabilize air bubbles can be due to the presence of materials that adsorb the stabilizing surfactant, i.e., fly ash with high surface area carbon or insufficient water for the surfactant to work properly, i.e., low slump concrete.

Formation of bubbles that are too large to provide resistance to freezing and thawing, can be the result of poor quality or poorly graded aggregates, use of other admixtures that destabilize the bubbles, etc. Such voids are often unstable and tend to float to the surface of the fresh concrete.

Removal of air by overfinishing, removes air from the surface of the concrete, typically resulting in distress by scaling of the detrained zone of cement paste adjacent to the overfinished surface.

The generation and stabilization of air at the time of mixing and ensuring it remains at the appropriate amount and air void size until the concrete hardens is a large challenge for concrete producers. The amount and type of air in a formulated concrete not only plays a role in concrete durability, but has an effect on concrete density and compressive strength.

Thus, there is a need in the art for methods and materials that allow for controlling the amount and type of air in concrete in a controlled and predictable manner to provide concrete with a desirable combination of durability and strength properties.

### SUMMARY OF THE INVENTION

The present invention provides a method of improving the durability of concrete formulations that includes combining cement, water, and optionally supplementary cementitious materials, aggregates, admixtures, and/or additives to form an aqueous cement mixture, adding prepuff particles to the cement mixture to form a concrete formulation, and curing the concrete formulation to a hardened mass. The aqueous cement mixture typically has a water to cementitious ratio of from 0.25 to 0.6. The prepuff particles are typically present in the concrete formulation at a level of from about 6 to 40 volume percent. The prepuff particles typically have an average particle diameter of from 0.2 mm to 3 mm, a bulk density of from 0.015 g/cc to 0.35 g/cc, an aspect ratio of from 1 to 3, and a smooth continuous outer surface. The cured and hardened concrete formulation typically has a relative dynamic modulus (RDM) of at least 70% determined according to Procedure A of ASTM C666 (2003).

The present invention also provides a concrete composition that includes cement, fine aggregate, coarse aggregate, water, and 6 to 40 volume percent prepuff particles where the water to cementitious ratio is from 0.25 to 0.6. The prepuff particles typically have an average particle diameter of from 0.2 mm to 3 mm, a bulk density of from 0.015 g/cc to 0.35 g/cc, an aspect ratio of from 1 to 3, and a smooth continuous outer surface. The cured and hardened concrete composition typically has a relative dynamic modulus (RDM) of at least 70% determined according to Procedure A of ASTM C666 (2003) and a 28 day compressive strength of at least 1400 psi as tested according to ASTM C39.

The present invention further provides a method of controlling the amount of air in concrete formulations that includes combining cement, water, and optionally supplementary cementitious materials, aggregates, admixtures and/or additives to form an aqueous cement mixture and adding expanded polymer particles to the cement mixture to form a concrete formulation. The prepuff particles typically have an average particle diameter of from 0.2 mm to 3 mm, a bulk density of from 0.015 g/cc to 0.35 g/cc, an aspect ratio of from 1 to 3, and a smooth continuous outer surface. The amount of measured air in the concrete formulation can be predictably increased based on the volume percent of expanded polymer particles over the amount of air in a similar concrete formulation not containing expanded polymer particles, as determined according to ASTM 0231.

### DESCRIPTION OF THE DRAWINGS

FIG. 1 is a scanning electron micrograph of the surface of a prepuff bead used in the invention;

FIG. 2 is a scanning electron micrograph of the interior of a prepuff bead used in the invention;

FIG. 3 is a scanning electron micrograph of the surface of a prepuff bead used in the invention;

FIG. 4 is a scanning electron micrograph of the interior of a prepuff bead used in the invention;

FIG. 5 is a scanning electron micrograph of the surface of a prepuff bead used in the invention;

FIG. 6 is a scanning electron micrograph of the interior of a prepuff bead used in the invention;

FIG. 7 is a graph showing the relationship between air content in a concrete formulation and the amount of expanded polymer particles in the concrete formulation;

FIG. 8 is a graph showing the relationship between air content in a concrete formulation and the amount of expanded polymer particles in the concrete formulation; and

FIG. 9 is a graph showing the relationship between prepuff compression with prepuff density and concrete density.

### DETAILED DESCRIPTION OF THE INVENTION

Other than in the operating examples or where otherwise indicated, all numbers or expressions referring to quantities of ingredients, reaction conditions, etc. used in the specification and claims are to be understood as modified in all instances by the term “about”. Accordingly, unless indicated to the contrary, the numerical parameters set forth in the following specification and attached claims are approximations that can vary depending upon the desired properties, which the present invention desires to obtain. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical values, however, inherently contain certain errors necessarily resulting from the standard deviation found in their respective testing measurements.

Also, it should be understood that any numerical range recited herein is intended to include all sub-ranges subsumed therein. For example, a range of “1 to 10” is intended to include all sub-ranges between and including the recited minimum value of 1 and the recited maximum value of 10; that is, having a minimum value equal to or greater than 1 and a maximum value of equal to or less than 10. Because the disclosed numerical ranges are continuous, they include every value between the minimum and maximum values. Unless expressly indicated otherwise, the various numerical ranges specified in this application are approximations.

As used herein, the term “particles containing void spaces” refers to expanded polymer particles, prepuff particles, and other particles that include cellular and/or honeycomb-type chambers at least some of which are completely enclosed, that contain air or a specific gas or combination of gasses, as a non-limiting example, prepuff particles as described herein.

As used herein, the term “prepuff” refers to an expandable particle, resin and/or bead that has been expanded, but has not been expanded to its maximum expansion factor.

As used herein, the term “micronized EPS” refers to EPS that was at least once molded into articles and subsequently reduced to small particles by crushing, tearing, slicing and/or cutting the article, typically as a means of recycling EPS material.

As used herein the terms “cement” and “cementitious” refer to materials that bond a concrete or other monolithic product, not the final product itself. In particular, hydraulic cement refers to a material that sets and hardens by undergoing a hydration reaction in the presence of a sufficient quantity of water to produce a final hardened product.

Cement materials include, but are not limited to, hydraulic cement, gypsum, gypsum compositions, lime and the like and may or may not include water. Adjuvants and fillers include, but are not limited to sand, clay, aggregate, air entraining admixtures, colorants, water reducers/superplasticizers, and the like.

As used herein, the terms “supplementary cementitious material” or “pozzolan” refer to a siliceous or siliceous and aluminous material, which in itself possesses little or no cementitious value, but which will in finely divided form and in the presence of moisture, chemically react with calcium hydroxide at ordinary temperatures to form compounds possessing cementitious properties. Non-limiting examples of supplementary cementitious materials or pozzolans include fly ash (C and F), silica fume, micronized silica, condensed silica fume, volcanic ashes, calcined clay, metakaolin clay, calcined shale and ground granulated blast furnace slag.

In particular embodiments of the invention further described herein, fly ash that has an LOI determined according to ASTM C 618 of greater than 6% is referred to as “high LOI fly ash”.

As used herein, the terms “water to cement ratio”, “water to cementitious ratio” and/or “w/c” refer to the ratio, based on the total weight of water to the total weight of cement or when appropriate ratio of water to the sum of cement and supplementary cementitious materials used in a concrete formulation.

As used herein, the term “concrete” refers to a hard, strong building material made by mixing a cementitious mixture with sufficient water to cause the cementitious mixture to set and bind the entire mass.

As used herein, the term “ready mix” refers to concrete that is batched for delivery from a central plant instead of being mixed on a job site. Typically, a batch of ready mix is tailor-made according to the specifics of a particular construction project and delivered in a plastic condition, usually in cylindrical trucks often referred to as “cement mixers”.

As used herein, the term “baseline air content” refers to the amount of air in a concrete formulation before prepuff or expanded polymer particles are added to the concrete formulation.

As used herein, the term “Dynamic Modulus” refers to a value determined on a concrete sample based on a viscoelastic test response developed under sinusoidal loading conditions. It is the absolute value of dividing the peak-to-peak stress by the peak-to-peak strain for a material subjected to a sinusoidal loading. Procedures for determining Dynamic Modulus are outlined in ASTM C666 (2003).

As used herein, the term “Relative Dynamic Modulus” or “RDM” refers to the ratio of the Dynamic Modulus measured on a concrete sample after exposure to a defined condition or set of conditions compared to the original value. As a non-limiting example, ASTM C666 (2003) can be used to determine RDM after exposure to a prescribed number of freeze thaw cycles.

All compositional ranges expressed herein are limited in total to and do not exceed 100 percent (volume percent or weight percent) in practice. Where multiple components can be present in a composition, the sum of the maximum amounts of each component can exceed 100 percent, with the understanding that, and as those skilled in the art readily understand, that the amounts of the components actually used will conform to the maximum of 100 percent.

As used herein, the terms “(meth)acrylic” and “(meth)acrylate” are meant to include both acrylic and methacrylic acid derivatives, such as the corresponding alkyl esters often referred to as acrylates and (meth)acrylates, which the term “(meth)acrylate” is meant to encompass.

As used herein, the term “polymer” is meant to encompass, without limitation, homopolymers, copolymers, graft copolymers, and blends and combinations thereof.

As used herein, the term “thermoplastic” refers to materials that are capable of softening, fusing, and/or modifying their shape when heated and of hardening again when cooled.

In its broadest context, the present invention provides a method of controlling the amount and type of air present in a formed concrete article. Thus, the present invention is directed to methods of controlling air entrainment where an article is formed by combining a concrete formulation and prepuff or expanded particles containing void spaces to provide a mixture and placing the mixture in a form.

Embodiments of the present invention are directed to concrete compositions that include a cementitious mixture and prepuff or expanded polymer particles. Surprisingly, it has been found that the size, composition, structure, and physical properties of the prepuff or expanded polymer particles, and in some instances their resin bead precursors, can greatly affect the physical properties of articles made using the methods and concrete compositions of the invention. In addition to the effect on density and strength, of particular note is the relationship between the prepuff or expanded particles and the amount of air present in a concrete formulation and the effect the air and/or prepuff particles have on the durability of the concrete.

The present invention provides methods of improving the durability of and/or controlling the amount of air in concrete formulations. The method includes (a) combining cement, water, and optionally supplementary cementitious materials, aggregates, admixtures, and/or additives to form an aqueous cement mixture; and (b) adding prepuff or expanded particles to the cement mixture to form a concrete formulation. In embodiments of the invention, the amount of air in the concrete formulation can be controlled based on the types of components in the cement mixture and the nature and characteristics of the prepuff or expanded particles.

The prepuff or expanded polymer particles, are present in the concrete formulation at a level of at least 6, in some situations at least 8, in other situations at least 10, in some instances at least 12, and in other instances at least 14 volume percent and up to 40, in some cases up to 38, in other cases up to 36, in some instances up to 34, in other instance up to 32, in particular instances up to 30, and in some cases up to 28 volume percent based on the total volume of the concrete formulation. The amount of prepuff or expanded polymer particles will vary depending on the particular cement mixture, the water to cement ratio, the presence or absence of air entraining admixtures and other additives and admixtures, and the amount of air desired in the concrete formulation. The amount of prepuff or expanded polymer particles in the concrete formulation can be any value or can range between any of the values recited above.

The water to cement ratio is often at least 0.25, in some instances at least 0.30 and can be up to 0.6, in some instances up to 0.55, in other instances up to 0.5, in some cases up to 0.45 and in other cases up to 0.41. The water to cement ratio can be any value recited above or range between any of the values recited above.

In many instances, a higher water to cement ratio can have a negative impact on durability. Thus, when the water to cement ratio is greater than 0.41, in some cases greater than 0.45 and in other cases 0.5 or greater, additional prepuff is required in the concrete composition to obtain acceptably durable concrete.

In some embodiments of the invention, the water to cement ratio can be up to 0.6 and the prepuff or expanded polymer particles, are present in the concrete formulation at a level of at least 12, in some situations at least 13, in other situations at least 14, in some instances at least 15, and in other instances at least 16 volume percent and up to 40, in some cases up to 38, in other cases up to 36, in some instances up to 34, in other instance up to 32, in particular instances up to 30, and in some cases up to 28 volume percent based on the total volume of the concrete formulation. The amount of prepuff or expanded polymer particles will vary depending on the particular water to cement ratio. The amount of prepuff or expanded polymer particles in concrete formulations having a water to cement ratio of up to 0.6 can be any value or can range between any of the values recited above.

In other embodiments of the invention, the water to cement ratio can be up to 0.45 and the prepuff or expanded polymer particles, are present in the concrete formulation at a level of at least 6, in some situations at least 7, in other situations at least 8, in some instances at least 10, and in other instances at least 12 volume percent and up to 40, in some cases up to 38, in other cases up to 36, in some instances up to 34, in other instance up to 32, in particular instances up to 30, and in some cases up to 28 volume percent based on the total volume of the concrete formulation. The amount of prepuff or expanded polymer particles will vary depending on the particular water to cement ratio. The amount of prepuff or expanded polymer particles in concrete formulations having a water to cement ratio of up to 0.45 can be any value or can range between any of the values recited above.

The prepuff or expanded polymer particles can include any particles derived from any suitable expandable thermoplastic material. The actual polymer particles are selected based on the particular physical properties desired in a finished concrete article. As a non-limiting example, the prepuff or expanded polymer particles, can include one or more polymers selected from homopolymers of vinyl aromatic monomers; copolymers of at least one vinyl aromatic monomer with one or more of divinylbenzene, conjugated dienes, alkyl methacrylates, alkyl acrylates, acrylonitrile, and/or maleic anhydride; polyolefins; polycarbonates; polyesters; polyamides; natural rubbers; synthetic rubbers; and combinations thereof.

In an embodiment of the invention, the prepuff or expanded polymer particles include thermoplastic homopolymers or copolymers selected from homopolymers derived from vinyl aromatic monomers including styrene, isopropylstyrene, alpha-methylstyrene, nuclear methylstyrenes, chlorostyrene, tert-butylstyrene, and the like, as well as copolymers prepared by the copolymerization of at least one vinyl aromatic monomer as described above with one or more other monomers, non-limiting examples being divinylbenzene, conjugated dienes (non-limiting examples being butadiene, isoprene, 1,3- and 2,4-hexadiene), alkyl methacrylates, alkyl acrylates, acrylonitrile, and maleic anhydride, wherein the vinyl aromatic monomer is present in at least 50% by weight of the copolymer. In an embodiment of the invention, styrenic polymers are used, particularly polystyrene. However, other suitable polymers can be used, such as polyolefins (e.g., polyethylene, polypropylene), polycarbonates, polyphenylene oxides, and mixtures thereof.

In a particular embodiment of the invention, the prepuff or expanded polymer particles are derived from expandable polystyrene (EPS) particles. These particles can be in the form of beads, granules, or other particles convenient for expansion operations.

In the present invention, particles polymerized in a suspension process, which are essentially spherical resin beads, are useful as polymer particles or for making prepuff or expanded polymer particles. However, polymers derived from solution and bulk polymerization techniques that are extruded and cut into particle sized resin bead sections can also be used.

In an embodiment of the invention, resin beads (unexpanded) containing any of the polymers or polymer compositions described herein have a particle size of at least 0.2, in some situations at least 0.33, in some cases at least 0.35, in other cases at least 0.4, in some instances at least 0.45 and in other instances at least 0.5 mm. Also, the resin beads can have a particle size of up to 3, in some instances up to 2, in other instances up to 2.5, in some cases up to 2.25, in other cases up to 2, in some situations up to 1.5 and in other situations up to 1 mm. The resin beads used in this embodiment can be any value or can range between any of the values recited above.

The expandable thermoplastic particles or resin beads can optionally be impregnated using any conventional method with a suitable blowing agent. As a non-limiting example, the impregnation can be achieved by adding the blowing agent to the aqueous suspension during the polymerization of the polymer, or alternatively by re-suspending the polymer particles in an aqueous medium and then incorporating the blowing agent as taught in U.S. Pat. No. 2,983,692. Any gaseous material or material which will produce gases on heating can be used as the blowing agent. Conventional blowing agents include aliphatic hydrocarbons containing 4 to 6 carbon atoms in the molecule, such as butanes, pentanes, hexanes, and the halogenated hydrocarbons, e.g., CFC's and HCFC's, which boil at a temperature below the softening point of the polymer chosen. Mixtures of these aliphatic hydrocarbon blowing agents can also be used.

Alternatively, water can be blended with these aliphatic hydrocarbon blowing agents or water can be used as the sole blowing agent as taught in U.S. Pat. Nos. 6,127,439; 6,160,027; and 6,242,540. In these patents, water-retaining agents are used. The weight percentage of water for use as the blowing agent can range from 1 to 20%. The texts of U.S. Pat. Nos. 6,127,439, 6,160,027 and 6,242,540 are incorporated herein by reference.

Suitable blowing agents that can be used in the invention include, but are not limited to, nitrogen, sulfur hexafluoride (SF₆), argon, carbon dioxide, 1,1,1,2-tetrafluoroethane (HFC-134a), 1,1,2,2-tetrafluoroethane (HFC-134), 1,1,1,3,3-pentafluoropropane, difluoromethane (HFC-32), 1,1-difluoroethane (HFC-152a), pentafluoroethane (HFC-125), fluoroethane (HFC-161) and 1,1,1-trifluoroethane (HFC-143a), methane, ethane, propane, n-butane, isobutane, n-pentane, isopentane, cyclopentane, neopentane, hexane, azodicarbonamide, azodiisobutyronitrile, benzenesulfonylhydrazide, 4,4-oxybenzene sulfonyl-semicarbazide, p-toluene sulfonyl semi-carbazide, barium azodicarboxylate, N,N′-dimethyl-N,N′-dinitrosoterephthalamide, trihydrazino triazine, mixtures of citric acid and sodium bicarbonate, and combinations thereof.

The impregnated polymer particles or resin beads are expanded to a bulk density of at least 0.9 lb/ft³ (0.015 g/cc), in some instances at least 1.25 lb/ft³ (0.02 g/cc), in some cases 1.75 lb/ft³ (0.028 g/cc), in some circumstances at least 21b/ft³ (0.032 g/cc), in other circumstances at least 31b/ft³ (0.048 g/cc) and, in particular circumstances, at least 3.25 lb/ft³ (0.052 g/cc) or 3.5 lb/ft³ (0.056 g/cc). In many situations, the polymer particles are at least partially expanded and the bulk density can be up to about 221b/ft³ (0.35 g/cc), in many instances up to about 20 lb/ft³ (0.32 g/cc), in some cases up to about 151b/ft³ (0.24 g/cc) and in other cases up to about 10 lb/ft³ (0.16 g/cc). The bulk density of the prepuff or expanded polymer particles can be any value or range between any of the values recited above. The bulk density of the expanded polymer particles and/or prepuff particles is determined by weighing a known volume of expanded polymer particles, beads and/or prepuff particles (aged 24 hours at ambient conditions).

The expansion step is conventionally carried out by heating the impregnated beads via any conventional heating medium, such as steam, hot air, hot water, or radiant heat. One generally accepted method for accomplishing the pre-expansion of impregnated thermoplastic particles is taught in U.S. Pat. No. 3,023,175.

The impregnated polymer particles can be foamed cellular polymer particles as taught in U.S. Patent Application Publication No. 2002/0117769 A1, the teachings of which are incorporated herein by reference. The foamed cellular particles can be polystyrene that are expanded and contain a volatile blowing agent at a level of less than 14 wt. %, in some situations less than 6 wt. %, in some cases ranging from about 2 wt. % to about 5 wt. %, and in other cases ranging from about 2.5 wt. % to about 3.5 wt. % based on the weight of the polymer.

An interpolymer of a polyolefin and in situ polymerized vinyl aromatic monomers that can be included in the expanded thermoplastic resin or polymer particles according to the invention is disclosed in U.S. Pat. Nos. 4,303,756 and 4,303,757, and 6,908,949, the relevant portions of which are herein incorporated by reference.

The polymer particles can include customary ingredients and additives, such as flame retardants, pigments, dyes, colorants, plasticizers, mold release agents, stabilizers, ultraviolet light absorbers, mold prevention agents, antioxidants, rodenticides, insect repellants, and so on. Typical pigments include, without limitation, inorganic pigments such as carbon black, graphite, expandable graphite, zinc oxide, titanium dioxide, and iron oxide, as well as organic pigments such as quinacridone reds and violets and copper phthalocyanine blues and greens.

In a particular embodiment of the invention, the pigment is carbon black, a non-limiting example of such a material being EPS SILVER™ available from NOVA Chemicals Inc.

In another particular embodiment of the invention, the pigment is graphite, a non-limiting example of such a material being NEOPOR®, available from BASF Aktiengesellschaft Corp., Ludwigshafen am Rhein, Germany.

When materials such as carbon black and/or graphite are included in the polymer particles, improved insulating properties, as exemplified by higher R values for materials containing carbon black or graphite (as determined using ASTM-C518), are provided. As such, the R value of the expanded polymer particles containing carbon black and/or graphite or materials made from such polymer particles are at least 5% higher than observed for particles or resulting articles that do not contain carbon black and/or graphite.

The expanded polymer particles or prepuff particles can have an average particle size of at least 0.2, in some circumstances at least 0.3, in other circumstances at least 0.5, in some cases at least 0.75, in other cases at least 0.9 and in some instances at least 1 mm and can be up to 3, in some circumstances up to 2.75, in other circumstances up to 2.5, in some cases up to 2.25, and in other cases up to 2 mm. When the size of the expanded polymer particles or prepuff particles are too small or too large, the physical properties of concrete articles made using the present method can be undesirable. The average particle size of the expanded polymer particles or prepuff particles can be any value and can range between any of the values recited above. The average particle size of the expanded polymer particles or prepuff particles can be determined using laser diffraction techniques or by screening according to mesh size using mechanical separation methods well known in the art.

The prepuff or expanded polymer particles can have any cross-sectional shape that allows for providing a predictable surface area and desirable physical properties in concrete formulations. In an embodiment of the invention, the prepuff or expanded polymer particles have a circular, oval or elliptical cross-section shape. In embodiments of the invention, the prepuff or expanded polymer particles have an aspect ratio of 1, in some cases at least 1 and the aspect ratio can be up to 3, in some cases up to 2 and in other cases up to 1.5. The aspect ratio of the prepuff or expanded polymer particles can be any value or range between any of the values recited above.

In an embodiment of the invention, the prepuff or expanded polymer particles have a minimum average cell wall thickness, which helps to provide desirable physical properties to articles made using the present concrete formulations. The average cell wall thickness and inner cellular dimensions can be determined using scanning electron microscopy techniques known in the art. The prepuff or expanded polymer particles can have an average cell wall thickness of at least 0.15 in some cases at least 0.2 μm and in other cases at least 0.25 Not wishing to be bound to any particular theory, it is believed that a desirable average cell wall thickness results when resin beads having the above-described dimensions are expanded to the above-described densities.

In an embodiment of the invention, the polymer beads are optionally expanded to form the prepuff or expanded polymer particles such that a desirable cell wall thickness as described above is achieved. Though many variables can impact the wall thickness, it is desirable, in this embodiment, to limit the expansion of the polymer bead so as to achieve a desired wall thickness and resulting expanded polymer particle strength. Optimizing processing steps and blowing agents can expand the polymer beads to a minimum of 1.25 lb/ft³ (0.02 g/cc). This property of the expanded polymer bulk density, can be described by pcf (lb/ft³) or by an expansion factor (cc/g).

As used herein, the term “expansion factor” refers to the volume a given weight of expanded polymer bead occupies, typically expressed as cc/g, and in the present invention, typically a value up to 50 cc/g.

In order to provide prepuff or expanded polymer particles with desirable cell wall thickness and strength, the prepuff or expanded polymer particles are not expanded to their maximum expansion factor; as such, an extreme expansion yields particles with undesirably thin cell walls and insufficient strength. Further, the polymer beads can be expanded at least 5%, in some cases at least 10%, and in other cases at least 15% of their maximum expansion factor. However, so as not to cause the cell wall thickness to be too thin, the polymer beads are expanded up to 80%, in some cases up to 75%, in other cases up to 70%, in some instances up to 65%, in other instances up to 60%, in some circumstances up to 55%, and in other circumstances up to 50% of their maximum expansion factor. The polymer beads can be expanded to any degree indicated above or the expansion can range between any of the values recited above. Typically, the polymer beads or prepuff particles do not further expand when formulated into the present cementitious compositions and do not further expand while the cementitious compositions set, cure and/or harden.

In embodiments of the invention, the prepuff particles can have an expansion factor of at least 10 and in some cases at least 12 cc/g and can be up to 70, in some cases up to 60 cc/g and in other cases up to 50 cc/g. The expansion factor of the prepuff particles can be any value or range between any of the values recited above.

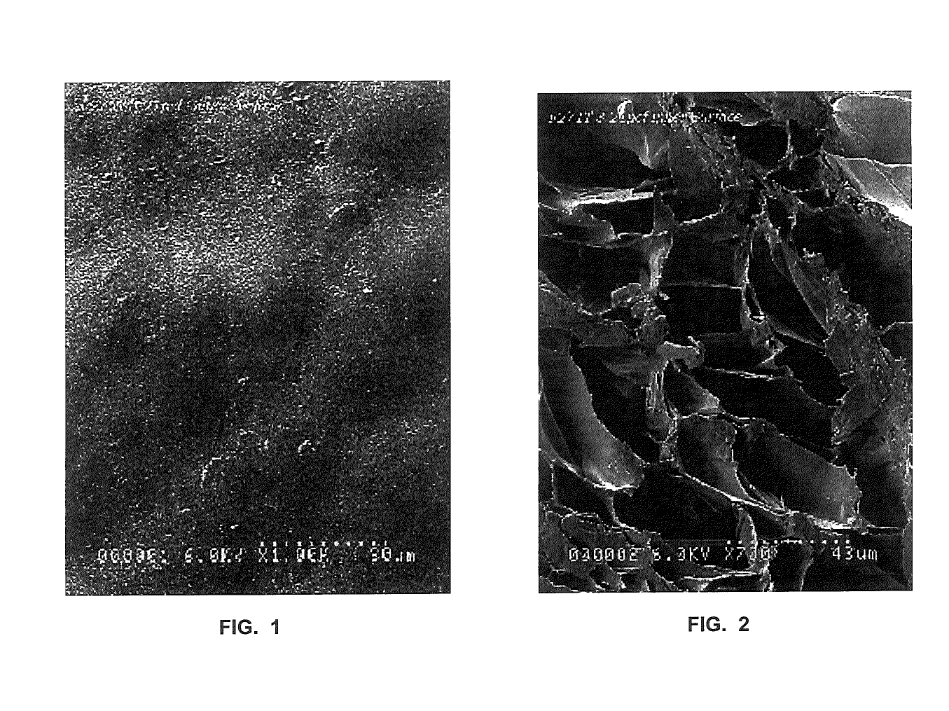

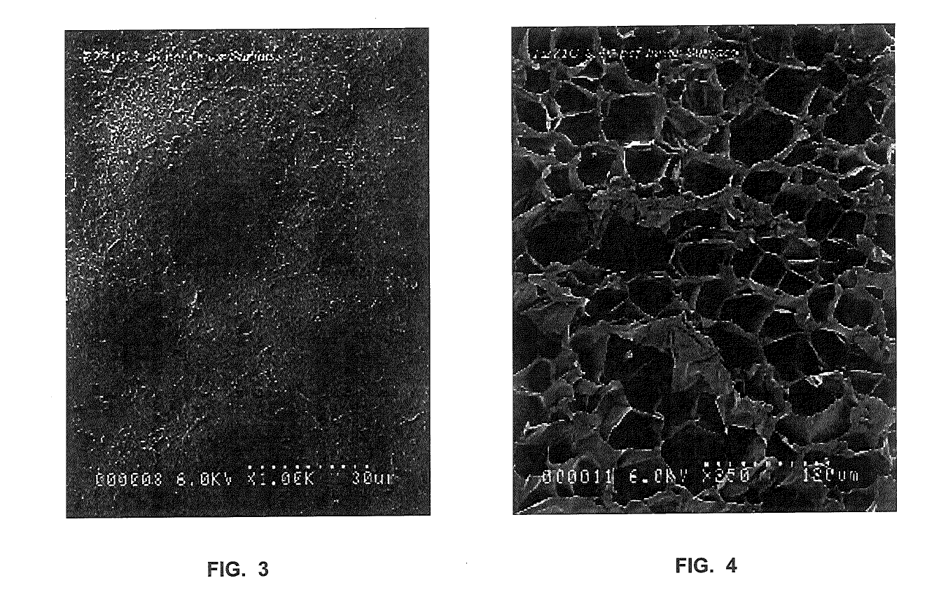

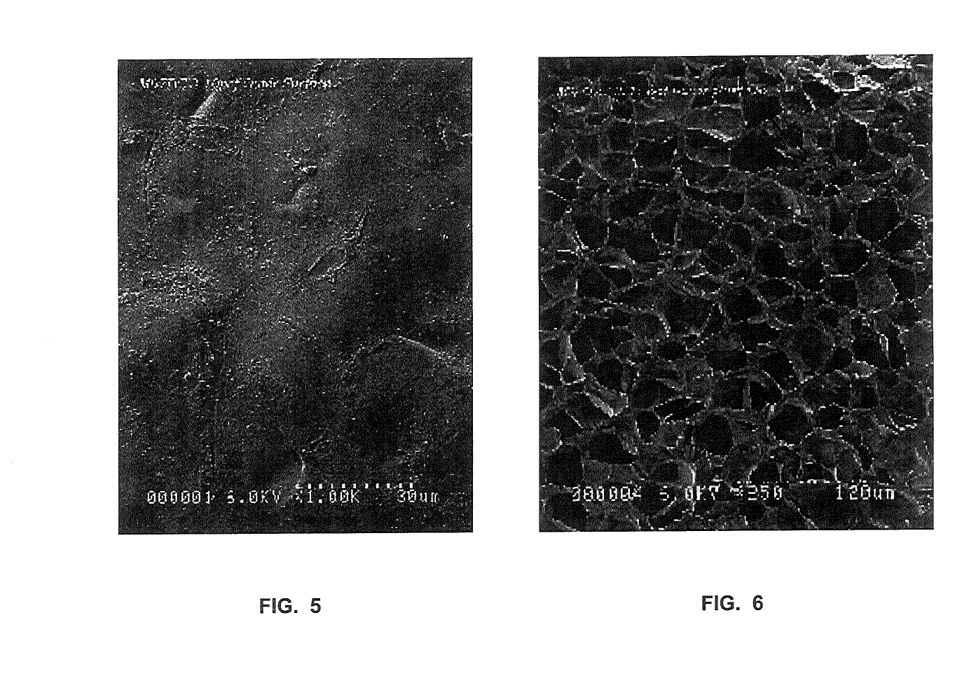

The prepuff or expanded polymer particles typically have a cellular structure or honeycomb interior portion and a continuous polymeric surface as an outer surface, i.e., a substantially continuous outer layer, which is smooth in some embodiments of the invention. The continuous surface can be observed using scanning electron microscope (SEM) techniques at 1000× magnification. SEM observations do not indicate the presence of holes in the outer surface of the prepuff or expanded polymer particles, as shown in FIGS. 1, 3 and 5. Cutting sections of the prepuff or expanded polymer particles and taking SEM observations reveals the generally honeycomb structure of the interior of the prepuff or expanded polymer particles, as shown in FIGS. 2, 4 and 6.

The continuous surface of the prepuff or expanded polymer particles provides a predictable surface area as opposed to using traditional micronized EPS in which the cellular structure of the EPS is exposed providing access to numerous structure, voids and additional surface area.

Not wishing to be limited to any single theory, it is believed that a layer of air forms along the surface of the prepuff or expanded polymer particles of the present invention when incorporated into concrete formulations. The predictable nature of the surface of the present prepuff or expanded polymer particles makes the amount of air in the concrete formulation predictable, and in many cases proportional to the surface area of the polymer particles.

When micronized EPS is used, the exposed surface area is large and unpredictable and the cellular voids entrain moisture from the concrete formulation causing an uncontrolled and large amount of air in the formulation, a “dry” concrete mix, that ultimately has less strength.

The aqueous cement mixture is present in the concrete formulations at a level of at least 10, in some instances at least 15, in other instances at least 22, in some cases at least 40 and in other cases at least 50 volume percent and can be present at a level of up to 90, in some circumstances up to 85, in other circumstances up to 80, in particular cases up to 75, in some cases up to 70, in other cases up to 65, and in some instances up to 60 volume percent of the concrete formulations. The cement mixture can be present in the concrete formulations at any level stated above and can range between any of the levels stated above.

In an embodiment of the invention, the aqueous cement mixture includes a hydraulic cement composition. The hydraulic cement composition can be present at a level of at least 8, in certain situations at least 9, in some cases at least 10, and in other cases at least 12 volume percent and can be present at levels up to 50, in some cases up to 45, in other cases up to 40, in some instances up to 35, in some situations up to 30, in other situations up to 35, in some instances up to 20 and in other instances up to 15 volume percent of the concrete formulation. The aqueous cement mixture can include the hydraulic cement composition at any of the above-stated levels or at levels ranging between any of levels stated above.

In a particular embodiment of the invention, the hydraulic cement composition can be one or more materials selected from Portland cements, gypsum cements, aluminous cements, and magnesia cements. Further, various cement types as defined in ASTM C150 can be used in the invention, non-limiting examples of which include Type I (for use when the special properties of other cement types are not required), Type IA (for air-entraining cement of Type I quality), Type II (for general use when moderate sulfate resistance or moderate heat of hydration is desired), Type IIA (for air-entraining cement of Type II quality), Type III (for use when high early strength is desired), Type IIIA (for air-entraining cement of Type III quality), Type IV (for use when a low heat of hydration is desired), Type V (for use when high sulfate resistance is desired) and combinations thereof.

In particular embodiment of the invention, the cement mixture includes one or more supplementary cementitious materials selected from type C fly ash, type F fly ash, silica fume, micronized silica, volcanic ash, calcined clay, metakaolin clay, ground granulated blast furnace slag and combinations thereof.

In an embodiment of the invention, the cement mixture and/or concrete formulations can optionally include other aggregates and adjuvants known in the art including but not limited to sand, additional aggregate, plasticizers and/or fibers.

In another embodiment of the invention, the concrete formulations can include reinforcement fibers. Such fibers act as reinforcing components, having a large aspect ratio, that is, their length/diameter ratio is high, so that a load is transferred across potential points of fracture. Suitable fibers include, but are not limited to glass fibers, silicon carbide, aramid fibers, polyester, polypropylene fibers, carbon fibers, composite fibers, fiberglass strands of approximately one to one and three fourths inches in length, and combinations thereof as well as fabric containing the above-mentioned fibers, and fabric containing combinations of the above-mentioned fibers. In many embodiments, the fibers have a higher Young's modulus than the matrix of the aqueous cement mixture or concrete formulation.

Non-limiting examples of fibers that can be used in the invention include MeC-GRID® and C-GRID® available from TechFab, LLC, Anderson, S C; KEVLAR® available from E.I. du Pont de Nemours and Company, Wilmington, Del.; TWARON® available from Teijin Twaron B. V., Arnheim, the Netherlands; SPECTRA® available from Honeywell International Inc., Morristown, N.J.; DACRON® available from Invista North America S.A.R.L. Corp. Wilmington, Del.; and VECTRAN® available from Hoechst Cellanese Corp., New York, N.Y. The fibers can be used in a mesh structure, intertwined, interwoven, and oriented in any desirable direction.

In a particular embodiment of the invention, fibers can make up at least 0.1, in some cases at least 0.5, in other cases at least 1, and in some instances at least 2 volume percent of the concrete formulations. Further, fibers can provide up to 10, in some cases up to 8, in other cases up to 7, and in some instances up to 5 volume percent of the concrete formulations. The amount of fibers is adjusted to provide desired properties to the concrete formulations. The amount of fibers can be any value or range between any of the values recited above.

In a particular embodiment of the invention, sand and/or other fine aggregate can make up at least 10, in some instances at least 11, in some cases at least 15, in other cases at least 20 volume percent of the concrete formulations. Further, sand and/or other fine aggregate can provide up to 50, in some cases up to 45, in other cases up to 40, and in some instances up to 35 volume percent of the concrete formulations. The amount of sand and/or other fine aggregate is adjusted to provide desired properties to the concrete formulations. The amount of sand and/or other fine aggregate can be any value or range between any of the values recited above.

In a particular embodiment of the invention, coarse aggregate (aggregate having an FM value of greater than 4) can make up at least 1, in some cases at least 5, in other cases at least 9, in some instances at least 12 and in other instances at least 15 volume percent of the concrete formulations. Further, coarse aggregate can provide up to 40, in some cases up to 35, in other cases up to 30, and, in some instances, up to 25 volume percent of the concrete formulations. The amount of coarse aggregate is adjusted to provide desired properties to the concrete formulations. The amount of coarse aggregate sand can be any value or range between any of the values recited above.

Further to this embodiment, the additional aggregate can include, but is not limited to, one or more materials selected from common aggregates such as sand, stone, and gravel. Common lightweight aggregates can include glass, expanded slate; insulating aggregates such as pumice, perlite, vermiculite, scoria, and diatomite; light weight concrete aggregate such as expanded shale, expanded clay, expanded slag, pelletized aggregate, tuff, and macrolite; and masonry aggregate such as expanded shale, clay, slate, expanded blast furnace slag, coal cinders, pumice, scoria, and pelletized aggregate.

As non-limiting examples, stone can include river rock, limestone, granite, sandstone, brownstone, conglomerate, calcite, dolomite, serpentine, travertine, slate, bluestone, gneiss, quarizitic sandstone, quartizite and combinations thereof.

When included, the other aggregates and adjuvants are present in the concrete formulations at a level of at least 0.5, in some cases at least 1, in other cases at least 2.5, in some instances at least 5 and in other instances at least 10 volume percent of the concrete formulations. Also, the other aggregates and adjuvants can be present at a level of up to 95, in some cases up to 90, in other cases up to 85, in some instances up to 65 and in other instances up to 60 volume percent of the concrete formulations. The other aggregates and adjuvants can be present in the concrete formulations at any of the levels indicated above or can range between any of the levels indicated above.

In embodiments of the invention, the concrete formulations can contain one or more additives, non-limiting examples of such being anti-foam agents, water-proofing agents, dispersing agents, bonding agents, freezing point decreasing agents, adhesiveness-improving agents, and colorants. The additives are typically present at less than one percent by weight with respect to total weight of the composition, but can be present at from 0.1 to 3 weight percent.

Suitable dispersing agents or plasticizers that can be used in the invention include, but are not limited to hexametaphosphate, tripolyphosphate, polynaphthalene sulphonate, sulphonated polyamine and combinations thereof.

Examples of suitable bonding agents include materials that can be either inorganic or organic and are soft and workable when fresh but set to form a hard, infusible solid on curing, either by hydraulic action or by chemical crosslinking. Non-limiting examples of such materials can include organic materials such as rubber, polyvinyl chloride, polyvinyl acetate, acrylics, styrene butadiene copolymers, and various powdered polymers.

Suitable defoaming agents that can be used in the invention include, but are not limited to silicone-based defoaming agents (such as dimethylpolysiloxane, dimethylsilicone oil, silicone paste, silicone emulsions, organic group-modified polysiloxanes (polyorganosiloxanes such as dimethylpolysiloxane), fluorosilicone oils, etc.), alkyl phosphates (such as tributyl phosphate, sodium octylphosphate, etc.), mineral oil-based defoaming agents (such as kerosene, liquid paraffin, etc.), fat- or oil-based defoaming agents (such as animal or vegetable oils, sesame oil, castor oil, alkylene oxide adducts derived therefrom, etc.), fatty acid-based defoaming agents (such as oleic acid, stearic acid, and alkylene oxide adducts derived therefrom, etc.), fatty acid ester-based defoaming agents (such as glycerol monoricinolate, alkenylsuccinic acid derivatives, sorbitol monolaurate, sorbitol trioleate, natural waxes, etc.), oxyalkylene type defoaming agents, alcohol-based defoaming agents: octyl alcohol, hexadecyl alcohol, acetylene alcohols, glycols, etc.), amide-based defoaming agents (such as acrylate polyamines, etc.), metal salt-based defoaming agents (such as aluminum stearate, calcium oleate, etc.) and combinations of the above-described defoaming agents.

Suitable freezing point decreasing agents that can be used in the invention include, but are not limited to ethyl alcohol, calcium chloride, potassium chloride, and combinations thereof.

Suitable adhesiveness-improving agents that can be used in the invention include, but are not limited to polyvinyl acetate, styrene-butadiene, homopolymers and copolymers of (meth)acrylate esters, and combinations thereof.

Suitable water-repellent or water-proofing agents that can be used in the invention include, but are not limited to fatty acids (such as stearic acid or oleic acid), lower alkyl fatty acid esters (such as butyl stearate), fatty acid salts (such as calcium or aluminum stearate), silicones, wax emulsions, hydrocarbon resins, bitumen, fats and oils, silicones, paraffins, asphalt, waxes, and combinations thereof. Although not used in many embodiments of the invention, when used, suitable air-entraining agents include, but are not limited to vinsol resins, sodium abietate, fatty acids and salts thereof, tensides, alkyl-aryl-sulfonates, phenol ethoxylates, lignosulfonates, and mixtures thereof.

In embodiments of the invention, the concrete formulations can contain one or more admixtures, non-limiting examples of such being retarding admixtures, accelerating admixtures, plasticizers, super plasticizers, water reducing admixtures and air-entraining admixtures. The admixtures are typically present at less than one percent by weight with respect to total weight of the composition, but can be present at from 0.1 to 3 weight percent.

Retarding admixtures are used to slow down the hydration of cement, lengthening the set time of the concrete formulation. In embodiments of the invention, retarders are used in hot weather conditions in order to overcome the accelerating effects of higher temperatures and large masses of concrete on concrete setting time. Since many retarders also act as water reducers, they can be referred to as water-reducing retarders. As a non-limiting example, in the chemical admixture classification in ASTM C 494, type B is simply a retarding admixture, while type D is both retarding and water reducing, resulting in concrete with greater compressive strength because of the lower water-cement ratio.

Suitable set-retarders that can be used in the invention include, but are not limited to lignosulfonates, hydroxycarboxylic acids (such as gluconic acid, citric acid, tartaric acid, maleic acid, salicylic acid, glucoheptonic acid, arabonic acid, and inorganic or organic salts thereof such as sodium, potassium, calcium, magnesium, ammonium and triethanolamine salt), cardonic acid, sugars, modified sugars, phosphates, borates, silico-fluorides, calcium bromate, calcium sulfate, sodium sulfate, monosaccharides such as glucose, fructose, galactose, saccharose, xylose, apiose, ribose and invert sugar, oligosaccharides such as disaccharides and trisaccharides, such oligosaccharides as dextrin, polysaccharides such as dextran, and other saccharides such as molasses containing these; sugar alcohols such as sorbitol; magnesium silicofluoride; phosphoric acid and salts thereof, or borate esters; aminocarboxylic acids and salts thereof; alkali-soluble proteins; humic acid; tannic acid; phenols; polyhydric alcohols such as glycerol; phosphonic acids and derivatives thereof, such as aminotri(methylenephosphonic acid), 1-hydroxyethylidene-1,1-diphosphonic acid, ethylene-diaminetetra(methylenephosphonic acid), diethylenetriamine-penta(methylenephosphonic acid), and alkali metal or alkaline earth metal salts thereof, and combinations of the set-retarders indicated above.

Accelerating admixtures shorten the set time of concrete, allowing a cold-weather pour, early removal of forms, early surface finishing, and in some cases, early load application. In many cases, the type and proportion of accelerators are chosen to minimize any increase in the drying shrinkage of concrete.

Suitable set-accelerators that can be used in the invention include, but are not limited to soluble chloride salts (such as calcium chloride), triethanolamine, paraformaldehyde, soluble formate salts (such as calcium formate), sodium hydroxide, potassium hydroxide, sodium carbonate, sodium sulfate, 12CaO.7Al₂O₃, sodium sulfate, aluminum sulfate, iron sulfate, the alkali metal nitrate/sulfonated aromatic hydrocarbon aliphatic aldehyde condensates disclosed in U.S. Pat. No. 4,026,723, the water soluble surfactant accelerators disclosed in U.S. Pat. No. 4,298,394, the methylol derivatives of amino acids accelerators disclosed in U.S. Pat. No. 5,211,751, and the mixtures of thiocyanic acid salts, alkanolamines, and nitric acid salts disclosed in U.S. Pat. No. Re. 35,194, the relevant portions of which are herein incorporated by reference, and combinations thereof.

Plasticizer and super plasticizer admixtures, include water-reducing admixtures. Compared to what is commonly referred to as a “water reducer” or “mid-range water reducer”, super plasticizers are “high-range water reducers”. High range water reducers are admixtures that allow large water reduction or greater flowability (as defined by the manufacturers, concrete suppliers and industry standards) without substantially slowing set time or increasing air entrainment.

Suitable plasticizing agents that can be used in the invention include, but are not limited to polyhydroxycarboxylic acids or salts thereof, polycarboxylates or salts thereof; lignosulfonates, polyethylene glycols, and combinations thereof.

Suitable superplasticizing agents that can be used in the invention include, but are not limited to alkaline or earth alkaline metal salts of lignin sulfonates; lignosulfonates, alkaline or earth alkaline metal salts of highly condensed naphthalene sulfonic acid/formaldehyde condensates; polynaphthalene sulfonates, alkaline or earth alkaline metal salts of one or more polycarboxylates (such as poly(meth)acrylates and the polycarboxylate comb copolymers described in U.S. Pat. No. 6,800,129, the relevant portions of which are herein incorporated by reference); alkaline or earth alkaline metal salts of melamine/formaldehyde/sulfite condensates; sulfonic acid esters; carbohydrate esters; and combinations thereof.

Non-limiting examples of suitable water reducers include lignosulfonates, sodium naphthalene sulfonate formaldehyde condensates, sulfonated melamine-formaldehyde resins, sulfonated vinylcopolymers, urea resins, and salts of hydroxy- or polyhydroxy-carboxylic acids, a 90/10 w/w mixture of polymers of the sodium salt of naphthalene sulfonic acid partially condensed with formaldehyde and sodium gluconate as described in U.S. Pat. No. 3,686,133, and combinations thereof.

Air-entraining admixtures entrain small air bubbles in the concrete. Conventional air entraining admixtures are used to enhanced durability in freeze-thaw cycles, especially relevant in cold climates and/or areas that experience many freeze-thaw cycles during the fall, winter and spring months. In some instances the use of air entraining admixtures causes strength loss that accompanies the increased air in concrete. In embodiments of the invention, this can be overcome by reducing the water-cement ratio.

In many embodiments of the invention, conventional air-entraining admixtures are not required for the present concrete formulations to demonstrate good durability properties. In particular embodiments of the invention conventional air-entrainment admixtures can be included in the present concrete formulations. In these particular embodiments of the invention, suitable air-entraining admixtures include, but are not limited to dilute aqueous solutions (5% to 20% by weight) of surfactants. Suitable surfactants include, but are not limited to (a) abietic and pimeric acids salts (neutralized wood resins), (b) fatty acid salts, (c) alkyl-aryl sulphonates, (d) alkyl sulphates, and (e) phenol ethoxylates. Particular non-limiting examples of conventional air entraining admixtures that can be used in the invention include the SIKH® AEA-14, AEA-15, AER, Air, and other air entraining admixtures available from Sika AG Corporation, Barr, Switzerland.

The cement mixture, prepuff or expanded polymer particles, and any other aggregates, admixtures, additives and/or adjuvants are mixed using methods well known in the art. In an embodiment of the invention, a liquid, in some instances, water, is also mixed into the other ingredients.

In an embodiment of the invention, the concrete composition is a dispersion where the cement mixture provides, at least in part, a continuous phase and the prepuff or expanded polymer particles exist as a dispersed phase of discrete particles in the continuous phase.

As a non-limiting embodiment of the invention and as not wishing to be limited to any single theory, some factors that can affect the performance of the present concrete formulations include the volume fraction of the expanded resin bead, the average expanded bead size and the microstructure created by the inter-bead spacing within the concrete. In this embodiment, the inter-bead spacing can be estimated using a two-dimensional model. For simplicity in description, the inter-bead spacing can be limited to the bead radius. Additionally, and without meaning to limit the invention in any way, it is assumed in this embodiment that the beads are arranged in a cubic lattice, bead size distribution in the light weight concrete composition is not considered, and the distribution of expanded bead area in the cross-section is not considered. In order to calculate the number of beads per sample, a three-dimensional test cylinder is assumed.

The smaller the expanded bead size, the greater the number of expanded beads required to maintain the same expanded bead volume fraction as described by equation 1 below. As the number of expanded beads increases exponentially, the spacing between the expanded beads decreases.

N_{b}=K/B³ (1)

N_{b} represents the number of expanded beads.

A concrete formulation test specimen with diameter D and height H (usually 2″×4″ or 6″×12″), containing dispersed expanded polymer beads of average expanded bead diameter B, and a given volume fraction V_{d} contains an amount of expanded polymer beads N_{b} given by equation 1:

Note that N_{b} is inversely proportional to the cube of the expanded polymer bead diameter. The constant of proportionality, K=1.5 V_{d}HD², is a number that is dependent only on the sample size and the volume fraction of expanded polymer beads. Thus for a given sample size, and known expanded polymer bead volume fraction, the number of beads increases to a third power as the bead diameter decreases.

As a non-limiting example, for a 2″×4″ light weight concrete specimen, at 90 pcf (lb/ft³) (corresponding to expanded polymer bead 43% volume fraction with pre-puff bulk density of 1.25 pcf), the number of beads increases fourfold and sevenfold moving from a 0.65 mm bead to 0.4 mm and 0.33 mm beads respectively. At 2.08 pcf, the increase in the number of beads is sixfold and sevenfold for 0.4 mm and 0.33 mm beads respectively. At 5 pcf, the increases are twofold and threefold respectively. Thus, the density correlates to the bead size. As shown below, the density also affects the cell wall thickness. The strength of a concrete matrix populated by expanded beads is typically affected by the cell wall stiffness and thickness. Additionally, the amount of expanded polymer particle surface area, and therefore air in the concrete formulations increases proportionally.

In an embodiment of the invention, where monodisperse spherical cells are assumed, it can be shown that the mean cell diameter d is related to the mean wall thickness δ by equation 2:

$$d = \frac{δ}{( \frac{1}{\sqrt{1 - ρ / {ρ}_{s}}} - 1 )} \qquad ( 2 )$$

where ρ is the density of the foam and ρₛ, is the density of the solid polymer bead.

Thus for a given polymer, depending on the particular expansion process used, one can obtain the same cell wall thickness (at a given cell size) or the same cell size at various values of δ. The density is controlled not only by the cell size but also by varying the thickness of the cell wall.

In many cases, the smaller the beads, the greater the number of beads required to maintain the same expanded polymer bead volume fraction as described by equation 1. As the number of beads increases exponentially, the spacing between the beads decreases.

The optimal bounds can be described by a number of relations representing critical numbers or limits. As a non-limiting example, for a given volume fraction, there is often a critical bead size corresponding to a critical number of beads that can be dispersed to provide a desired morphology such that all the beads are isolated and the concrete is singly connected and air is uniformly dispersed within the concrete formulations.

In a particular embodiment of the invention, the concrete composition contains at least some of the expanded polymer particles or prepuff particles arranged in a cubic or hexagonal lattice.

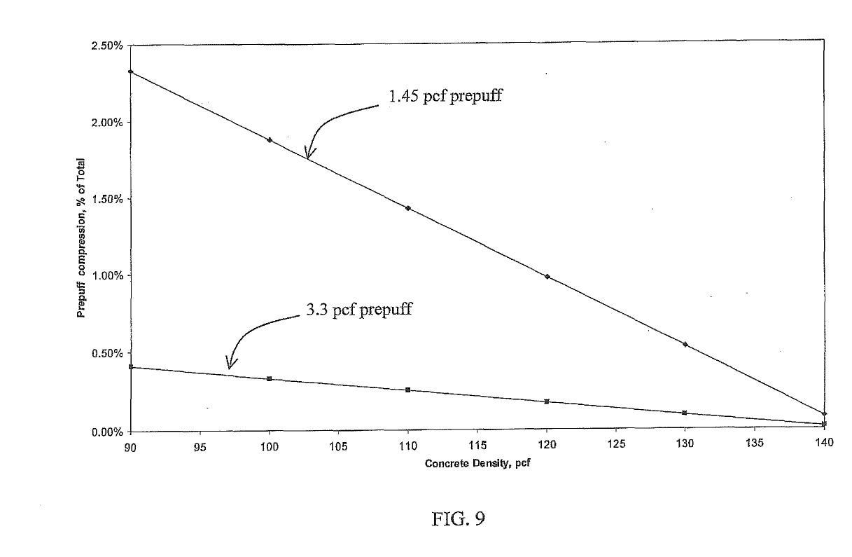

Depending on the density of the prepuff or expanded polymer particles used in a concrete formulation the prepuff particles can be more fragile at low densities (as a non-limiting example, a bulk density of about 1.45 pcf) or less fragile at higher densities (as a non-limiting example, a bulk density of about 3,3 pcf). As an example, the hydrostatic pressure prepuff particles are exposed to in a concrete formulation can vary depending on the density of the particular concrete formulation resulting in the prepuff particles being elastically compressed, resulting in their taking up a smaller volume when under pressure. Higher density prepuff particles deform less under pressure than lower density particles. These types of volume changes in prepuff particle volume can cause variability in test results. FIG. 9 shows an example of this type of variability where the amount of prepuff particle compression is depicted as a function of concrete density at various prepuff particle bulk densities when exposed to the maximum pressure (13 psi) when performing the air test according to ASTM C231.

The concrete formulations according to the invention can be set and/or hardened to form final concrete articles using methods well known in the art.

In embodiments of the invention, the density of the concrete formulations of the invention can be at least 40 lb/ft³ (0.64 g/cc), in some cases at least 45 lb/ft³ (0.72 g/cc) and in other cases at least 50 lb/ft³ (0.8 g/cc) lb/ft³ and the density can be up to 145 lb/ft³ (2.32 g/cc), often up to 140 lb/ft³ (2.24 g/cc), in some situations up to 135 lb/ft³ (2.16 g/cc), in other situations up to 130 lb/ft³ (2.08 g/cc), in some cases 120 lb/ft³ (1.9 g/cc), in other cases up to 115 lb/ft³ (1.8 g/cc), in some circumstances up to 110 lb/ft³ (1.75 g/cc), in other circumstances up to 105 lb/ft³ (1.7 g/cc), in some instances up to 100 lb/ft³ (1.6 g/cc), and in other instances up to 95 lb/ft³ (1.5 g/cc). The density of the present concrete articles can be any value and can range between any of the values recited above. The density of the concrete formulations is determined according to ASTM C 138. The density of the concrete formulation will depend on the particular characteristics desired in the concrete, non-limiting examples being durability, strength, modulus, etc. The density of the present concrete formulation will depend on the amount and density of prepuff particles used as well as the amount and density of various aggregates, additives and admixtures employed.

In embodiments of the invention, the set and/or hardened concrete formulations according to the invention are used in structural applications and can have a minimum compressive strength for load bearing masonry structural applications of at least 1400 psi (98 kgf/cm²), in some cases 1700 psi (119.5 kgf/cm²), in other cases at least 1800 psi (126.5 kgf/cm²), in some instances at least 1900 psi, and in other instances at least 2000 psi (140.6 kgf/cm²). For some structural concrete applications, the present concrete compositions can have a minimum compressive strength of at least 2500 psi (175.8 kgf/cm²). Compressive strengths are determined according to ASTM C39 at 28 days.

Although ASTM C39 can be consulted for precise details, and is incorporated by reference herein in its entirety, it can be summarized as providing a test method that consists of applying a compressive axial load to molded cylinders or cores at a rate which is within a prescribed range until failure occurs. The testing machine is equipped with two steel bearing blocks with hardened faces, one which is a spherically seated block that will bear on the upper surface of the specimen, and the other a solid block on which the specimen rests. The load is applied at a rate of movement (platen to crosshead measurement) corresponding to a stress rate on the specimen of 35±7 psi/s (0.25±0.05 Mpa/s). The compressive load is applied until the load indicator shows that the load is decreasing steadily and the specimen displays a well-defined fracture pattern. The compressive strength is calculated by dividing the maximum load carried by the specimen during the test by the cross-sectional area of the specimen.

The present invention provides methods of controlling the amount of air in concrete formulations. In embodiments of the invention, the amount of air in the concrete formulations can vary with the volume of prepuff or expanded polymer particles in the concrete formulation. Typically, the components of a concrete formulation provide an amount of air content in the concrete formulation. This amount of air can be increased or decreased based on various additives and/or admixtures that can be included in the concrete formulation. For example, conventional air entraining admixtures can be included in the concrete formulation. This amount of air is considered the baseline air content.

The amount of air in a concrete formulation can be increased as the volume of prepuff or expanded polymer particles added to the concrete formulation increases. The ratio of air volume to expanded polymer particle volume will vary depending on the type, size and surface area of the expanded polymer particle and the type and variety of components in the concrete formulation and can be linear or non-linear based on the various variables that can be changed in a concrete formulation.

The baseline air content can vary based on the composition of the concrete formulation without the prepuff or expanded polymer particles. As a non-limiting example, many admixtures, additives and aggregates are surface active and either increase or decrease the baseline air content in a concrete formulation.

In embodiments of the invention when no conventional air entraining admixtures are included in the concrete formulation without prepuff or expanded polymer particles, the baseline air content can be at least about 0.1, in some cases at least about 0.5, in other cases at least about 0.75 and in other cases at least about 1 volume percent of the concrete formulation without prepuff or expanded polymer particles. Also, the baseline air content can be up to about 5, in some cases up to about 4.5, in other cases up to about 4 and in other cases up to about 3.5 volume percent of the concrete formulation without prepuff or expanded polymer particles. The amount of baseline air in the concrete formulation can be affected by the amount and type of mixing used to make the concrete formulation as well as the consistency of the concrete formulation. The amount of baseline air in the concrete formulations of these embodiments of the invention, without prepuff or expanded polymer particles, can be any value or range between any of the values recited above.

In other embodiments of the invention when conventional air entraining admixtures are included in the concrete formulation, without prepuff or expanded polymer particles, the baseline air content can be at least about 1, in some cases at least about 2, in other cases at least about 2.5 and in other cases at least about 3 volume percent of the concrete formulation with conventional air entraining admixtures and without prepuff or expanded polymer particles. Also, the baseline air content can be up to about 10, in some cases up to about 9, in other cases up to about 8 and in other cases up to about 7 volume percent of the concrete formulation with conventional air entraining admixtures and without prepuff or expanded polymer particles. The amount of air in the concrete formulation can be affected by the amount and type of conventional air entraining admixtures used, the amount and type of mixing used to make the concrete formulation as well as the consistency of the concrete formulation. The amount of baseline air in concrete formulations that include conventional air entraining admixtures and without prepuff or expanded polymer particles can be any value or range between any of the values recited above.

In embodiments of the invention, the amount of measured air in a concrete formulation is increased above the baseline measured air content by at least 0.05, in some cases at least 0.075 and in other cases at least 0.1 volume percent, as determined according to ASTM C231, for each one volume percent of prepuff or expanded polymer particles included in the concrete formulation. Also, the amount of air in a concrete formulation can be increased above the baseline air content by up to 0.25, in some cases up to 0.2 and in other cases up to 0.175 volume percent for each one volume percent of prepuff or expanded polymer particles. The amount that the air in a concrete formulation is increased above the baseline air content can be any value or range between any of the values recited above and will vary depending on the particular additives and admixtures included in a concrete formulation.

Typically, the prepuff or expanded polymer particles of the present invention do not fit the industry accepted definition of a lightweight or normal weight aggregates as defined by ACI 318, ASTM C33 or ASTM C330. In many instances, it is more appropriate to classify the present prepuff or expanded polymer particles as an additive or admixture. This classification is consistent with the ACI 318 admixture definition “Material other than water, aggregate, or hydraulic cement, used as an ingredient of concrete and added to concrete before or during its mixing to modify its properties”. While there are two generally accepted test methods to determine the amount of air in wet concrete, evaluations of each test method (ASTM C231-pressure method/ASTM C173 volumetric method) indicated that the pressure method (ASTM C231) is the proper method of measurement for concrete formulations utilizing the present prepuff or expanded polymer particles.

Embodiments of the invention provide a method of controlling the amount of measured air in concrete formulations that includes combining cement, water, and optionally aggregate and optionally additives to form an aqueous cement mixture; determining the amount of air in the cement mixture (the baseline air content); and adding prepuff or expanded polymer particles to the cement mixture to form a concrete formulation containing a predetermined desired amount of air, determined according to ASTM C231. Thus, when the relationship between measured air content in a given cement mixture and/or concrete formulation is established using the present prepuff or expanded polymer particles, the desired amount of measured air content in the concrete formulation can be provided within the concrete density parameters dictated by the type, amount, bulk density, and size of the prepuff or expanded polymer particles to be used.

In embodiments of the invention, the present concrete formulations provide superior freeze-thaw and durability properties as determined according to Procedure A of ASTM C666 (2003) “Standard Test Method for Resistance to Rapid Freezing and Thawing”.

Further to these embodiments, concrete formulations prepared according to the present invention can have a relative dynamic modulus (RDM) of at least 70%, in some instances at least 75%, in other instances at least 80%, in some cases at least 85%, and, in other some cases at least 90% determined according to Procedure A of ASTM C666 (2003).

Additional embodiments of the invention provide a method of improving the durability of concrete formulations that includes combining cement, water, and optionally aggregate, admixtures and/or additives to form an aqueous cement mixture; adding the present prepuff or expanded polymer particles to the cement mixture to form a concrete formulation; and curing the concrete formulation to a hardened mass that can have a relative dynamic modulus (RDM) of at least 70%, in some instances at least 75%, in other instances at least 80%, in some cases at least 85%, and in other cases at least 90% determined according to Procedure A of ASTM C666 (2003).

While the inventors do not wish to be bound by any particular theory, the incorporation of prepuff particles as described herein in the concrete formulations used in the present method are believed to improving concrete durability in at least two ways.

First, because the prepuff particles have a generally smooth continuous polymeric surface as an outer surface, i.e., a substantially continuous outer layer, the amount of water they absorb or adsorb is minimal. So, unlike micronized EPS, no water is available in the prepuff particles to freeze. Secondly, the spacing, size, shape, continuous outer layer, and honeycomb structure of the prepuff particles allow them to deform when force from forming ice crystals is exerted on them, relieving stress from the concrete. When the ice melts, the thermoplastic nature of the prepuff particles allows them to roughly return to their original shape. This action helps to minimize crack formation or prevent it all together.

When the concrete formulations of the invention are used in road bed construction, the prepuff or expanded polymer particles can aid in preventing and or minimizing crack propagation, especially when water freeze-thaw is involved.

The present concrete formulations can be used in most, if not all, applications where traditional concrete formulations are used. As non-limiting examples, the present concrete formulations can be used in structural and architectural applications, non-limiting examples being party walls, ICF or SIP structures, bird baths, benches, shingles, siding, drywall, cement board, decorative pillars or archways for buildings, etc., furniture or household applications such as counter tops, in-floor radiant heating systems, floors (primary and secondary), tilt-up walls, sandwich wall panels, as a stucco coating, road and airport safety applications such as arresting walls, Jersey Barriers, sound barriers and walls, retaining walls, runway arresting systems, air entrained concrete, runaway truck ramps, flowable excavatable backfill, and road construction applications such as road bed material and bridge deck material.

A particular advantage in some embodiments is that the present set concrete compositions not containing coarse aggregate and/or molded construction articles formed from such compositions can be readily cut and/or sectioned using conventional methods as opposed to having to use specialized concrete or diamond tipped cutting blades and/or saws. This provides substantial time and cost savings when customizing concrete articles.

The compositions can be readily cast into molds according to methods well known to those of skill in the art for, as non-limiting examples, roofing tiles, paver, or other articles in virtually any three dimensional configuration desired, including configurations having certain topical textures such as having the appearance of wooden shakes, slate shingles or smooth faced ceramic tiles. A typical shingle can have approximate dimensions of ten inches in width by seventeen inches in length by one and three quarters inches in thickness. In the molding of roofing materials, the addition of air entraining admixtures makes the final product more weatherproof in terms of resistance to freeze/thaw degradation.

When foundation walls are poured using the concrete formulations of the invention, the walls can be taken above grade due to the lighter weight. Ordinarily, the lower part of the foundation wall has a tendency to blow outwards under the sheer weight of the concrete mixture, but the lighter weight of the compositions of the invention tend to lessen the chances of this happening. Foundation walls prepared using the present concrete formulations can readily take conventional fasteners used in conventional foundation wall construction.

In an embodiment of the invention, the concrete compositions according to the invention are formed, set and/or hardened in the form of a concrete masonry unit. As used herein, the term “concrete masonry unit” refers to a hollow or solid concrete article including, but not limited to scored, split face, ribbed, fluted, ground face, slumped and paving stone varieties. Embodiments of the invention provide walls that include, at least in part, concrete masonry units made according to the invention.

In an embodiment of the invention, when coarse aggregate is not used, the molded construction articles and materials and concrete masonry units described above are capable of receiving and holding penetrating fasteners, non-limiting examples of such include nails, screws, staples and the like. This can be beneficial in that surface coverings can be attached directly to the molded construction articles and materials and concrete masonry units molded construction articles and materials and concrete masonry units.

In an embodiment of the invention, a standard 2½ inch drywall screw can be screwed into a poured and set surface containing the present light weight concrete composition, to a depth of 1½ inches, and is not removed when a force of at least 500, in some cases, at least 600 and in other cases at least 700 and up to 800 pounds of force is applied perpendicular to the surface screwed into for one, in some cases five and, in other cases, ten minutes.

In embodiments of the invention, the concrete formulations of the invention are used in ready mix applications. As a non-limiting example, ready mixed concrete formulations can be used when small quantities of concrete or intermittent placing of concrete are required or for large jobs where space is limited and there is little room for a mixing plant and aggregate stockpiles.

As non-limiting examples, ready mix can include central-mixed concrete, transit-mixed concrete, and shrink-mixed concrete.

Central-mixed concrete is completely mixed at a plant and then transported in a truck-mixer or agitator truck. Freshly mixed concrete formulations can be transported in an open dump truck if the jobsite is near the plant. Slight agitation of the concrete during transit prevents segregation of the materials and reduces the amount of slump loss.

In transit-mixed (also known as truck-mixed) concrete, materials are batched at a central plant and are completely mixed in the truck in transit. Frequently, the concrete formulation is partially mixed in transit and mixing is completed at the jobsite. Transit-mixing keeps the water separate from the cement and aggregates and allows the concrete to be mixed immediately before placement at the construction site. This method avoids the problems of premature hardening and slump loss that result from potential delays in transportation or placement of central-mixed concrete. Additionally, transit-mixing allows concrete to be hauled to construction sites further away from the plant. A disadvantage to transit-mixed concrete, however, is that the truck capacity is smaller than that of the same truck containing central-mixed concrete.

Shrink-mixed concrete is used to increase the truck's load capacity and retain the advantages of transit-mixed concrete. In shrink-mixed concrete, the concrete formulation is partially mixed at the plant to reduce or shrink the volume of the mixture and mixing is completed in transit or at the jobsite.

Ready mixed concrete is often remixed once it arrives at the jobsite to ensure that the proper slump is obtained. However, concrete that has been remixed tends to set more rapidly than concrete mixed only once. Materials, such as water and some varieties of admixtures, are often added to the concrete formulation at the jobsite after it has been batched to ensure that the specified properties are attained before placement.

In a particular embodiment of the invention, the present concrete formulations are used in ready mix applications and contain from 8 to 20 volume percent of a cement composition that includes type I Portland Cement; from 7 to 30 volume percent water, from 6 to 40 volume percent of prepuff or expanded polymer particles having an average particle diameter of from 0.2 mm to 3 mm, a bulk density of from 0.015 g/cc to 0.35 g/cc, and an aspect ratio of from 1 to 3; from 11 to 50 volume percent of one or more fine aggregates; from 9 to 40 volume percent of one or more coarse aggregates; and optionally from 0.1 to 1 volume percent of one or more additives and/or admixtures selected from anti-foam agents, water-proofing agents, dispersing agents, set-accelerators, set-retarders, plasticizing agents, superplasticizing agents, conventional air entraining admixtures, freezing point decreasing agents, adhesiveness-improving agents, colorants and combinations thereof; where the sum of components used does not exceed 100 volume percent. Typically, after these concrete formulations are set, they have a compressive strength of at least 1400 psi as tested according to ASTM C39 after 28 days.

The concrete ready mix formulations of the invention are often designed for specific applications. As non-limiting examples, a high slump concrete ready mix composition can be desirable when the concrete must be placed around a high concentration of reinforcing steel. Also, a low slump concrete ready mix composition can be desirable when concrete is placed in large open forms, or when the form is placed on a slope.

As such, in some embodiments of the invention, the ready mix compositions will have a measurable slump value, sampled according to ASTM C 172 (Standard Practice for Sampling Freshly Mixed Concrete) and measured according to ASTM C 143 (Standard Test Method for Slump of Hydraulic Cement Concrete). The exact slump value is designed into a particular mix and will depend on the application and the design of the ready mix composition. In typical use, the slump will range from at least about 1 inch (2.5 cm), in some instances at least about 2 inches (5 cm) and in some cases at least about 3 inches (7.6 cm) to up to about 8 inches (20 cm), in some cases up to about 7 inches (18 cm) and in other cases up to about 6 inches (15 cm). If the concrete delivered to a project is too stiff (low slump) it may be difficult to discharge it from a truck. If the slump is too high, the concrete may not be useable. In this embodiment, the slump can be any value recited above or range between any of the recited values.

In another particular embodiment of the invention, the ready mix composition is used in traditional ready mix applications, which include, but are not limited to tilt up construction, pour in place, lightweight grouts, ICF fill and other applications where concrete is poured or pumped and transported, for example, in ready-mix trucks to job sites.

The concrete ready mix compositions of the invention can include the formulations and compositions described above.

In many of the embodiments of the invention, concrete ready mix compositions are prepared by combining one or more of the following components: sand, coarse aggregate, cement, water; optionally additives and/or admixtures; prepuff particles, polymer particles and/or expanded polymer particles, and water reducer. The cement, water, fine aggregates, course aggregates, water, additives, admixtures and prepuff particles can be combined and mixed using one or more pieces of mixing equipment selected from one or more of a concrete mixing truck, a pan style mixer, and a drum style mixer.

The water to cement ratio is often at least 0.25, in some instances at least 0.30 and can be up to 0.6, in some instances up to 0.55, in other instances up to 0.5, in some cases up to 0.45 and in other cases up to 0.41. The water to cement ratio can be any value recited above or range between any of the values recited above.

The concrete ready mix compositions of the invention can utilize any suitable cement, non-limiting examples including Type I, Type II, and Type III and combinations thereof. In particular embodiments of the invention, the cement is present in the ready mix composition, at from at least about 8 and in some cases at least about 10 volume percent and can be up to about 20, in some cases up to about 17 volume percent and in particular instances about 14 volume percent. The exact amount of cement is designed into a particular mix and will depend on the type of cement, intended application and the design of the ready mix composition. The amount of cement in the concrete ready mix compositions can be any value or range between any of the values recited above.

In this particular embodiment of the invention, fine aggregates or sand, as described above, are present in the ready mix composition, at from at least about 11, in some cases at least about 14, and in other cases at least about 17 volume percent and can be up to about 50, in some cases up to about 40, and in other cases up to about 30 volume percent. The exact amount of sand is designed into a particular mix and will depend on the type of sand (coarse or fine), intended application and the design of the ready mix composition. The amount of sand in the concrete ready mix compositions can be any value or range between any of the values recited above.

Further to this particular embodiment of the invention, the prepuff particles and/or expanded polymer particles of the invention can be present at form at least about 6, in some cases at least about 8, and in other cases at least about 10 volume percents and can be present at up to about 40, in some cases up to about 35, and in other cases up to about 31 volume percent. The exact amount of prepuff particles and/or expanded polymer particles is designed into a particular mix and will depend on the density of the expanded polymer particles and/or prepuff particles, intended application and the design of the ready mix composition as well as the desired durability of the concrete. The amount of prepuff particles and/or expanded polymer particles in the concrete ready mix compositions can be any value or range between any of the values recited above.

Additionally, in the ready mix particular embodiments of the invention, coarse aggregate such as stone, as described above, can be present in the ready mix composition, at from at least about 9, in some cases at least about 14, and in other cases at least about 17 volume percent and can be up to about 40, in some cases up to about 30, and in other cases up to about 25 volume percent. The exact amount, type and size of coarse aggregate is designed into a particular mix and will depend on the intended application and the design of the ready mix composition. The amount of coarse aggregate in the concrete ready mix compositions can be any value or range between any of the values recited above. The coarse aggregate can have a diameter of from at least about 0.375 inches (0.95 cm), in some cases about 0.5 inches (1.3 cm), in other cases about 0.75 inches (1.9 cm) to up to about 2 inches (5 cm).

Also, in these particular embodiments of the invention, water can be present in the ready mix composition, at from at least about 7 volume percent, in some cases at least about 10 volume percent up to about 30 volume percent, in some instances up to about 25 volume percent, in other instances up to about 22 volume percent, in some cases up to about 20 volume percent and in other cases up to about 18 volume percent. The amount of water in the light weight concrete ready mix compositions can be any value or range between any of the values recited above and is typically determined based on the desired water to cement ratio in a concrete formulation.

The concrete ready mix compositions of these embodiments when set and/or hardened can have a compressive strength of at least about 1400 psi (98 kgf/cm²), in some cases at least about 1500 psi (105.5 kgf/cm²), in other cases at least about 1600 psi (112.5 kgf/cm²), in some instances at least about 1800 psi (126.5 kgf/cm²), and in other instances at least about 2000 psi (140.6 kgf/cm²) and optionally can be up to about 3600 psi (253 kgf/cm²) in some cases up to about 3300 psi (232 kgf/cm²) and in other cases up to about 3000 psi (211 kgf/cm²).

The exact compressive strength of a concrete ready mix composition will depend on its formulation, density and intended application. The compressive strength of the concrete ready mix compositions can be any value or range between any of the values recited above.

The compositions of the invention are well suited to the fabrication of molded construction articles and materials, non-limiting examples of such include wall panels including tilt-up wall panels, T beams, double T beams, roofing tiles, roof panels, ceiling panels, floor panels, I beams, foundation walls and the like. The compositions exhibit greater durability than prior art concrete formulations.

In an embodiment of the invention, the molded construction articles and materials can be precast and/or prestressed.

As used herein, “precast” concrete refers to concrete poured into a mold or cast of a required shape and allowed to cure and/or harden before being taken out and put into a desired position.

As used herein, “prestressed” concrete refers to concrete whose tension has been improved by using prestressing tendons (in many cases, high tensile steel cable or rods), which are used to provide a clamping load producing a compressive strength that offsets the tensile stress that the concrete member would otherwise experience due to a bending load. Any suitable method known in the art can be used to prestress concrete. Suitable methods include, but are not limited to pre-tensioned concrete, where concrete is cast around already tensioned tendons, and post-tensioned concrete, where compression is applied after the pouring and curing processes.

In embodiments of the invention, the concrete formulations used in precast applications, which include, but are not limited to precast parts such as beams, double-Ts, pipes, insulated walls, prestressed products, and other products where the concrete formulations is poured directly into forms and final parts are transported to job sites by truck.

In embodiments of the invention where the present concrete formulations are used in precast and/or prestressed applications, the concrete formulation typically includes from 10 to 50 volume percent of cement; from 6 to 40 volume percent of prepuff or expanded polymer particles having an average particle diameter of from 0.2 mm to 3 mm, a bulk density of from 0.015 g/cc to 0.35 g/cc, and an aspect ratio of from 1 to 3; from 10 to 50 volume percent of one or more fine aggregates; from 5 to 35 volume percent of one or more coarse aggregates; and optionally from 0.1 to 1 volume percent of one or more additives and/or admixtures selected from anti-foam agents, water-proofing agents, dispersing agents, set-accelerators, set-retarders, plasticizing agents, superplasticizing agents, conventional air entraining admixtures, freezing point decreasing agents, adhesiveness-improving agents, colorants and combinations thereof; where the sum of components used does not exceed 100 volume percent.

In these embodiments of the invention, the slump flow (determined according to ASTM C 143) value ranges from at least about 8 inch (20 cm) and in some cases at least about 10 inches (25.4 cm) to up to about 28 inches (70 cm), in some situations about 26 inches (66 cm), in some instances up to about 23 inches (58 cm), in other instances up to about 20 inches (50 cm), in some cases, up to about 18 inches (46 cm) and, in other cases, up to about 16 inches (41 cm). In these embodiments, the slump flow can be any value or range between any of the recited values.

In particular embodiments of the invention, the concrete compositions can have 28-day compressive strengths of at least about 2500 psi (175 kgf/cm²), in some cases at least about 3000 psi (210 kgf/cm²), in other cases at least about 3500 psi (245 kgf/cm²), in some instances at least about 4000 (281 kgf/cm²), and in other instances at least about 4500 psi (316 kgf/cm²). In these embodiments, compressive strengths are determined according to ASTM C39 at 28 days. The exact compressive strength of the concrete formulation will depend on its formulation, density and intended application. The compressive strength of the concrete formulation can be any value or range between any of the values recited above.

In other particular aspects of these embodiments, the concrete compositions can have structural compressive strengths of about 4000 psi (281 kgf/cm²) or greater in 48 hours for post-tensioned applications.

In embodiments of the invention, the methods of improving the durability of and/or controlling air in concrete formulations described herein can be particularly effective with concrete formulations that include high LOI fly ash. While these materials typically make it very difficult to maintain adequate air in a concrete formulation, when the prepuff or expanded polymer particles according to the present method are added, sufficient air is placed in the concrete formulation to provide good durability in the formulations described herein, particularly those containing 1-50 volume percent of fly ash having an LOI determined according to ASTM C 618 of greater than 6% (“High LOI Fly Ash”). The levels of measured air placed in such concrete formulations are as described above and can be at least 4, in some cases at least 5 and in other cases at least 6 volume percent determined according to ASTM C231 using fly ash that has an LOI of greater than 6%, in some cases greater than 7%, in other cases greater than 8%, in some instances greater than 10% and in other instances greater than 12% determined according to ASTM C 618.

While high LOI fly ash is typically placed in landfills due to the difficulty of producing adequately durable concrete containing it, the inclusion of the present prepuff or expanded polymer particles in concrete formulations containing high LOI fly ash overcomes these problems and provides durable concrete that can be used in ready-mix, precast, and precast-prestressed applications that can include, without limitation, structural and architectural applications such as party walls, ICF or SIP structures, bird baths, benches, shingles, siding, drywall, cement board, decorative pillars or archways for buildings, etc., furniture or household applications such as counter tops, in-floor radiant heating systems, floors (primary and secondary), tilt-up walls, sandwich wall panels, as a stucco coating, road and airport safety applications such as arresting walls, Jersey Barriers, sound barriers and walls, retaining walls, runway arresting systems, air entrained concrete, runaway truck ramps, flowable excavatable backfill, and road construction applications such as road bed material and bridge deck material.

The present invention will further be described by reference to the following examples. The following examples are merely illustrative of the invention and are not intended to be limiting. Unless otherwise indicated, all percentages are by weight and Portland cement is used unless otherwise specified.

### EXAMPLES

Unless otherwise indicated, the following materials were utilized:
Type III Portland Cement
Mason Sand (165 pcf bulk density, 2.64 specific gravity, fineness modulus=1.74)
Potable Water—ambient temperature (˜70° F./21° C.)
Expandable Polystyrene—M97BC, F271C, F271M, F271T (NOVA Chemicals Inc., Pittsburgh, Pa.) or EMX-2020 (Syntheon Inc., Pittsburgh, Pa.).
EPS Resin—1037C (NOVA Chemicals Inc.)
½ inch Expanded Slate (Carolina Stalite Company, Salisbury, N.C.—89.5 pcf bulk density/1.43 specific gravity)

Unless otherwise indicated, all compositions were prepared under laboratory conditions using a model 42N-5 blender (Charles Ross & Son Company, Hauppauge, N.Y.) having a 7-ft³ working capacity body with a single shaft paddle. The mixer was operated at 34 rpm. Conditioning was performed in a LH-10 Temperature and Humidity Chamber (manufactured by Associated Environmental Systems, Ayer, Mass.). Samples were molded in 6″×12″ single use plastic cylinder molds with flat caps and were tested in triplicate. Compression testing was performed on a Forney FX250/300 Compression Tester (Forney Incorporated, Hermitage, Pa.), which hydraulically applies a vertical load at a desired rate. All other peripheral materials (slump cone, tamping rods, etc.) adhered to the applicable ASTM test method. The following ASTM test methods and procedures were followed:
ASTM C470—Standard Specification for Molds for Forming Concrete Test Cylinders Vertically
ASTM C192—Standard Practice for Making and Curing Concrete Test Specimens in the Laboratory
ASTM C330—Standard Specification for Lightweight Aggregates for Structural Concrete
ASTM C511—Standard Specification for Mixing Rooms, Moist Cabinets, Moist Rooms, and Water Storage Tanks Used in the Testing of Hydraulic Cements and Concretes
ASTM C143—Standard Test Method for Slump of Hydraulic-Cement Concrete
ASTM C1231—Standard Practice for Use of Unbonded Caps in Determination of Compressive Strength of Hardened Concrete Cylinders
ASTM C39—Standard Test Method for Compressive Strength of Cylindrical Concrete Specimens

Cylinders were kept capped and at ambient laboratory conditions for a maximum of 24 hours. Cylinders were then stripped and cured following ASTM C511 procedures. Unless otherwise noted, cylinders were tested for compressive strength following ASTM C39 at 28-day age.

### Example 1

Polystyrene in unexpanded bead form (M97BC—0.65 mm, F271T—0.4 mm, and F271M—0.33 mm) was pre-expanded into EPS foam (prepuff) particles of varying densities as shown in the table below.

| | | Prepuff Particle | | |
|---|---|---|---|---|
| | Bead | Bulk | | |
| Bead | Mean | Density, | | Standard |
| Type | Size, μm | lb/ft³ | Mean Size, μm | deviation, μm |
| F271M | 330 | 2.32 | 902 | 144 |
| F271M | 330 | 3.10 | 824 | 80 |
| F271M | 330 | 4.19 | 725 | 103 |
| F271T | 400 | 2.40 | 1027 | 176 |
| F271T | 400 | 3.69 | 1054 | 137 |
| F271T | 400 | 4.57 | 851 | 141 |
| M97BC | 650 | 2.54 | 1705 | 704 |
| M97BC | 650 | 3.29 | 1474 | 587 |
| M97BC | 650 | 5.27 | 1487 | 584 |

The data show that the prepuff particle size generally varies inversely with the expanded density of the material.

### Example 2

Prepuff from F271T bead expanded to 1.2 lb/ft³, F271C bead expanded to 1.3 lb/ft³ and M97BC bead expanded to 1.5 lb/ft³ were evaluated using scanning electron microscopy (SEM). The surface and inner cells of each are shown in FIGS. 1 and 2 (F271T), 3 and 4 (F271C), and 5 and 6 (M97BC) respectively.

As shown in FIGS. 1, 3 and 5, the external structure of the prepuff particles was generally spherical in shape having a continuous surface outer surface or skin. As shown in FIGS. 2, 4 and 6, the internal cellular structure of the prepuff samples resembles a honeycomb-type structure.

The size of the prepuff particles was also measured using SEM, the results are shown in the table below.

| | T prepuff | C prepuff | BC prepuff |
|---|---|---|---|
| (microns) | (1.2 pcf) | (1.3 pcf) | (1.5 pcf) |
| Outer diameter | 1216 | 1360 | 1797 |
| Internal cell size | 42.7 | 52.1 | 55.9 |
| Internal cell wall | 0.42 | 0.34 | 0.24 |
| Cell wall/cell | 0.0098 | 0.0065 | 0.0043 |
| size | | | |
| | | C prepuff | BC prepuff |
| | | (3.4 pcf) | (3.1 pcf) |
| Outer diameter | — | 1133 | 1294 |
| Internal cell size | — | 38.2 | 31.3 |
| Internal cell wall | — | 0.26 | 0.47 |
| Cell wall/cell | — | 0.0068 | 0.0150 |
| size | | | |

Taken with all of the data presented herein, the data provide an indication that internal cellular structure might affect the strength of a concrete formulation.

When used in concrete formulations, the prepuff particles can impact the overall strength of the concrete in two ways. First, the larger particles, which have a lower density, change the concrete matrix surrounding the prepuff particle and secondly, the lower density prepuff particle is less rigid due to the cell structure of the foamed particle. Since the strength of the concrete depends, at least to some extent, on the strength of the prepuff particles, increased prepuff particle strength should result in greater relative concrete strength. The potential strength increase can be limited by the extent to which it impacts the concrete matrix. The data in the present examples suggest that the original bead particle size can be optimized to provide an optimally sized prepuff particle (which is controlled by the prepuff density), which results in a unique combination of the highest possible concrete strength at the lowest concrete density.

In other words, within an optimum prepuff particle size and optimum density range, the wall thickness of the prepuff will provide sufficient support to allow the present light weight concrete composition to have better strength than EPS containing concrete compositions in the prior art.

The data presented herein demonstrate that unlike the presumption and approach taken in the prior art, expanded EPS particles can do surprisingly more than act simply as a void space in the concrete. More specifically, the structure and character of the prepuff particles used in the present invention can significantly enhance the durability and strength of the resulting light weight concrete composition.

### Example 3

Polystyrene in unexpanded bead form (0.65 mm) was pre-expanded into prepuff particles having various densities as shown in the table below. The prepuff particles were formulated into concrete formulations in a 3.5 cubic foot drum mixer, containing the components shown in the table below.

| | Sample A | Sample B |
|---|---|---|
| Prepuff Particle Bulk | 3.9 | 5.2 |
| Density (lb/ft³) | | |
| Portland Cement, wt. % | 46 (21.5) | 45.6 (21.4) |
| (vol. %) | | |
| Water, wt. % (vol. %) | 16.1 (22.4) | 16 (22.3) |
| Prepuff, wt. % (vol. %) | 2.3 (37.3) | 3 (37.5) |
| Sand, wt. % (vol. %) | 35.6 (18.8) | 35.4 (18.7) |

The following data table numerically depicts the relationship between prepuff density and concrete strength at a constant concrete density.

| | Bead | Prepuff Particle | Concrete | |
|---|---|---|---|---|
| | Mean Size, | Bulk Density, | Density, | 7-day Compressive |
| | μm | lb/ft³ | lb/ft³ | Strength, psi |
| Sample A | 650 | 3.9 | 85.3 | 1448 |
| Sample B | 650 | 5.2 | 84.3 | 1634 |

The data show that as prepuff particle density in the concrete formulation increases at constant concrete density, the compressive strength of the concrete increases.

### Example 4

The following examples demonstrate the use of expanded slate as an aggregate used in combination with the prepuff particles of the present invention. Polystyrene in unexpanded bead form was pre-expanded into prepuff particles having various densities as shown in the table below. The prepuff particles were formulated into concrete formulations in a 3.5 cubic foot drum mixer, containing the components shown in the table below.

| | Example C | Example D | Example E | Example F | Example G |
|---|---|---|---|---|---|
| Bead size (mm) | 0.4 | 0.4 | 0.4 | 0.4 | 0.4 |
| Prepuff density | 3.4 | 3.4 | 3.4 | 3.4 | 3.4 |
| (lb./ft³) | | | | | |
| Weight % | | | | | |
| Cement | 35.0% | 36.2% | 37.3% | 35.9% | 37.1% |
| Sand | 23.2% | 9.9% | 0.0% | 15.8% | 1.9% |
| Prepuff | 1.5% | 1.4% | 0.6% | 1.5% | 1.3% |
| Slate | 26.3% | 38.1% | 47.1% | 32.4% | 44.7% |
| Water | 14.0% | 14.5% | 14.9% | 14.4% | 14.9% |
| Total | 100.0% | 100.0% | 100.0% | 100.0% | 100.0% |
| water/cement | 0.40 | 0.40 | 0.40 | 0.40 | 0.40 |
| Volume % | | | | | |
| Cement | 16.1% | 16.1% | 18.3% | 16.1% | 16.1% |
| Sand | 12.1% | 5.0% | 0.0% | 8.0% | 1.0% |
| Prepuff | 27.3% | 24.4% | 11.9% | 26.4% | 23.4% |
| Slate | 25.2% | 35.3% | 48.0% | 30.3% | 40.3% |
| Water | 19.2% | 19.2% | 21.8% | 19.2% | 19.2% |
| Total | 100.0% | 100.0% | 100.0% | 100.0% | 100.0% |
| 7-day | 2536 | 2718 | 4246 | 2549 | 2516 |
| compressive | | | | | |
| strength (psi) | | | | | |
| density (pcf) | 91.1 | 90.7 | 98.0 | 89.7 | 89.9 |

### Example 5

One-foot square, 4 inch thick concrete forms were made by pouring formulations prepared according to examples H and I in the table below into forms and allowing the formulations to set for 24 hours.

| | Example H | Example I |
|---|---|---|
| bead size (mm) | 0.4 | 0.65 |
| Prepuff density | 3.4 | 4.9 |
| (lb./ft³) | | |
| wt % | | |
| Cement | 35.0% | 33.1% |
| Sand | 23.2% | 45.4% |
| Prepuff | 1.5% | 2.9% |
| Slate | 26.3% | 0.0% |
| Water | 14.0% | 13.2 |
| water/cement | 0.40 | 40.0% |
| Volume % | | |
| Cement | 16.1% | 16.0% |
| Sand | 12.1% | 24.7% |
| EPS | 27.3% | 40.3% |
| Slate | 25.2% | 0.0% |
| Water | 19.2% | 19.1% |
| 7-day | 2536 | 2109 |
| compressive | | |
| strength (psi) | | |
| density (pcf) | 91.1 | 90.6 |

After 7 days, a one-foot square, ½ inch sheet of plywood was fastened directly to the formed concrete. A minimum of one-inch penetration was required for adequate fastening. The results are shown in the table below.

| Fastener | Example H | Example I |
|---|---|---|
| 7 d coated nails | | |
| attachment | No penetration when | 100% penetration and |
| | slate is encountered | attachment |
| removal | Easily removed | Could not be manually |
| | | removed from the |
| | | concrete without |
| | | mechanical assistance |
| 2½ inch standard | | |
| dry wall screw | | |
| attachment | No penetration when | 100% penetration and |
| | slate is encountered | attachment. Screw broke |
| | | before concrete failed. |
| removal | Easily removed | Could not be manually |
| | | removed from the |
| | | concrete without |
| | | mechanical assistance. |
| | | Screw could be removed |
| | | and reinserted with no |
| | | change in holding power. |

The data demonstrates that the present concrete formulation, without slate, provides superior gripping capability with plywood using standard fasteners compared to traditional expanded slate formulations, while slate containing concrete did not readily accept fasteners. This represents an improvement over the prior art as the time consuming practice of fixing anchors into the concrete to enable the fasteners to grip thereto can be eliminated.

### Example 6

One-foot square, 4 inch thick concrete forms were made by pouring the formulations of Examples H and I into forms and allowing the formulations to set for 24 hours. After 7 days, a one-foot square, ½ inch sheet of standard drywall sheet was fastened directly to the formed concrete using standard 1¾ inch drywall screws. A minimum of one-inch screw penetration was required for adequate fastening. The results are shown in the table below.

| Fastener | | |
|---|---|---|
| 1¾ inch standard | | |
| dry wall screw | Example H | Example I |
| attachment | No penetration when | 100% penetration and |
| | slate is encountered | attachment. Screw |
| | | could penetrate |
| | | through the drywall. |
| removal | Easily removed. | Could not be manually |
| | | removed from the |
| | | concrete without |
| | | mechanical assistance. |
| | | Screw could be |
| | | removed and |
| | | reinserted with no |
| | | change in holding |
| | | power. |

The data demonstrates that the present concrete formulations, without slate, provides superior gripping capability compared to traditional expanded slate formulations, which did not readily accept fasteners. This represents an improvement over the prior art as the time consuming practice of fastening studs to the concrete to allow for attaching the drywall thereto can be eliminated.

### Example 7

Two-foot square, 4 inch thick concrete forms were made by pouring the formulations Examples H and I into a form and allowing the formulations to set for 24 hours. After 7 days, a three foot long, 2″×4″ stud was fastened directly to the formed concrete using standard 16d nails. A minimum of two-inch nail penetration was required for adequate fastening. The results are shown in the table below.

| Fastener | | |
|---|---|---|
| 16d nail | Example H | Example I |
| attachment | No penetration when slate is | 100% penetration and |
| | encountered | attachment. |
| removal | Easily removed. | Could not be manually |
| | | removed from the concrete |
| | | without mechanical |
| | | assistance. |

The data demonstrates that the present concrete formulations, without slate, provides superior gripping capability compared to traditional expanded slate formulations, which did not readily accept fasteners. This represents an improvement over the prior art as the expensive and time consuming practice of using TAPCON® (available from Illinois Tool Works Inc., Glenview, Ill.) or similar fasteners, lead anchors, or other methods known in the art to fasten studs to concrete can be eliminated.

### Example 8

The following examples demonstrate the use of the prepuff particles of the present invention in ready-mix formulations. Polystyrene in unexpanded bead form (F271 available from NOVA Chemicals Inc.) was pre-expanded into prepuff particles having various densities as shown below. The prepuff particles were formulated into ready-mix compositions, in a 2.2 ft³ pan-style mixer, (READYMAN® 120, IMER USA Inc., San Francisco, Calif.) containing the components shown in the tables below. The ingredients were combined in the following order: sand (coarse, 2.5 specific gravity), coarse aggregate, Portland cement (Type 1, CEMEX), prepuff, and water. Cylinders (4″×8″) were prepared according to ASTM C192 and cured according to ASTM C511.

| | Sample | | | | | |
|---|---|---|---|---|---|---|
| | J^{a} | K^{a} | L^{a} | M^{a} | N^{a} | O^{a} |
| Weight Percent | | | | | | |
| Cement | 23.18% | 24.30% | 22.28% | 20.56% | 22.97% | 23.93% |
| Sand | 52.47% | 50.19% | 54.60% | 58.32% | 50.33% | 49.16% |
| Prepuff | 0.29% | 1.02% | 0.68% | 0.39% | 0.76% | 0.92% |
| Coarse Aggregate | 13.85% | 14.52% | 13.31% | 12.29% | 15.83% | 15.47% |
| Water | 10.20% | 9.96% | 9.13% | 8.43% | 10.11% | 10.53% |
| Volume Percent | | | | | | |
| Cement | 13.60% | 13.60% | 13.60% | 13.60% | 13.60% | 13.60% |
| Sand | 38.17% | 34.84% | 41.34% | 47.84% | 36.95% | 34.65% |
| Prepuff | 19.38% | 24.00% | 17.50% | 11.00% | 19.07% | 22.08% |
| Coarse Aggregate | 10.00% | 10.00% | 10.00% | 10.00% | 11.53% | 10.82% |
| Water | 18.85% | 17.56% | 17.56% | 17.56% | 18.85% | 18.85% |
| Slump (in) | 2.75 | 4 | 4 | 3 | 2 | 1.25 |
| Wet Density (pcf) | 120.4 | 113.1 | 117.7 | 125.36 | 116.56 | 113.6 |
| W/C Ratio | 0.44 | 0.44 | 0.44 | 0.44 | 0.44 | 0.44 |
| Prepuff Density (pcf) | 1.3 | 3.45 | 3.45 | 3.45 | 3.45 | 3.45 |
| Expansion Factor (cc/g) | 48 | 18 | 18 | 18 | 18 | 18 |
| Compressive Strength | | | | | | |
| 3-day | 3000 | 2106 | 2179 | 2400 | 2728 | 2495 |
| 7-day | 3542 | 2260 | 2516 | 2809 | 3075 | 2825 |
| 28-day | 4132 | 2800 | 3100 | 3600 | 3760 | 3459 |

| | Sample | | | | |
|---|---|---|---|---|---|
| | P^{a} | Q^{a} | R^{a} | S^{b} | T^{ac} |
| Weight Percent | | | | | |
| Cement | 24.93% | 22.94% | 21.26% | 15.91 | 22.97% |
| Sand | 47.38% | 51.98% | 55.87% | 58.55 | 50.68% |
| Prepuff | 1.81% | 1.27% | 0.80% | .30 | 0.30% |
| Coarse Aggregate | 14.90% | 13.71% | 12.71% | 18.25 | 15.94% |
| Water | 10.97% | 10.10% | 9.36% | 7 | 10.11% |
| Volume Percent | | | | | |
| Cement | 13.60% | 13.60% | 13.60% | 9.41 | 13.60% |
| Sand | 32.05% | 38.21% | 44.32% | 42.94 | 37.22% |
| Prepuff | 25.50% | 19.34% | 13.23% | 18.22 | 18.72% |
| Coarse Aggregate | 10.00% | 10.00% | 10.00% | 13.39 | 11.61% |
| Water | 18.85% | 18.85% | 18.85% | 13.04 | 18.85% |
| Slump (in) | 2.25 | 4 | 2.25 | 1 | 7 |
| Wet Density (pcf) | 106.72 | 115.2 | 123.68 | 118.96 | 120.5 |
| W/C Ratio | 0.44 | 0.44 | 0.44 | 0.62 | 0.44 |
| Prepuff Density (pcf) | 5.65 | 5.65 | 5.65 | 1.4 | 1.4 |
| Expansion Factor (cc/g) | 11 | 11 | 11 | 45 | 45 |
| Compressive Strength | | | | | |
| 3-day | 2036 | 2696 | 3425 | 1155 | 2496 |
| 7-day | 2225 | 3035 | 3978 | 1442 | 3051 |
| 28-day | 2738 | 3600 | 4654 | 1685 | 3394 |

^{a}coarse aggregate was ¾ inch river gravel
^{b}coarse aggregate was ⅜ inch river gravel
^{c}includes 1 ounce/cwt of THOROBOND ® polyvinyl acetate bonding agent from Degussa Building Systems, Shakopee, MN.

The data indicate that excellent compressive strength can be obtained using ready-mix formulations containing prepuff particles according to the invention.

### Example 9

The following examples demonstrate the controlled and predictable effect on air content that the expanded polymer particles provide in ready-mix formulations that do not contain admixtures or conventional air entraining admixtures. Polystyrene in unexpanded bead form (EMX-2020) was pre-expanded into prepuff particles having the density shown below. The prepuff particles were formulated into ready-mix compositions, in a 4 ft³ drum-style mixer, containing the components shown in the tables below. The ingredients were combined in the following order: sand (ASTM C33 grade), coarse aggregate (67 river rock), Portland cement (Type 1, Lehigh Cement Company, Allentown, Pa.), prepuff, and water. Air content was determined by ASTM C231. Slump and/or slump flow values were determined by sampling according to ASTM C 172 and measuring according to ASTM C 143.

| | Sample | | | | | | |
|---|---|---|---|---|---|---|---|
| | U | V | W | X | Y | Z | AA |
| (lb./yd³) | | | | | | | |
| Cement | 722 | 722 | 722 | 722 | 722 | 722 | 722 |
| Sand | 2120 | 2054 | 1920 | 1720 | 1519 | 1319 | 1119 |
| Prepuff | 0 | 1 | 3 | 6 | 9 | 12 | 15 |
| Coarse | 643 | 643 | 643 | 643 | 643 | 643 | 643 |
| Aggregate | | | | | | | |
| Water | 361 | 361 | 361 | 361 | 361 | 361 | 361 |
| Volume | | | | | | | |
| Percent | | | | | | | |
| Cement | 13.9 | 13.9 | 13.9 | 13.9 | 13.9 | 13.9 | 13.9 |
| Sand | 48.9 | 47.4 | 44.3 | 39.7 | 35.0 | 30.4 | 25.8 |
| Prepuff | 0 | 1.5 | 4.6 | 9.2 | 13.9 | 18.5 | 23.1 |
| Coarse | 15.3 | 15.3 | 15.3 | 15.3 | 15.3 | 15.3 | 15.3 |
| Aggregate | | | | | | | |
| Water | 21.9 | 21.9 | 21.9 | 21.9 | 21.9 | 21.9 | 21.9 |
| Slump (in) | 6.0 | 6.0 | 7.2 | 7.5 | 5 | 6.5 | 6.0 |
| Wet Density | 142 | 139 | 135 | 128 | 123 | 117 | 108 |
| (pcf) | | | | | | | |
| W/C Ratio | 0.5 | 0.5 | 0.5 | 0.5 | 0.5 | 0.5 | 0.5 |
| Prepuff | — | 1.38 | 1.38 | 1.38 | 1.38 | 1.38 | 1.38 |
| Density (pcf) | | | | | | | |
| Air (vol. %) | 2.3 | 3.2 | 3.1 | 3.6 | 4.3 | 4.5 | 4.6 |

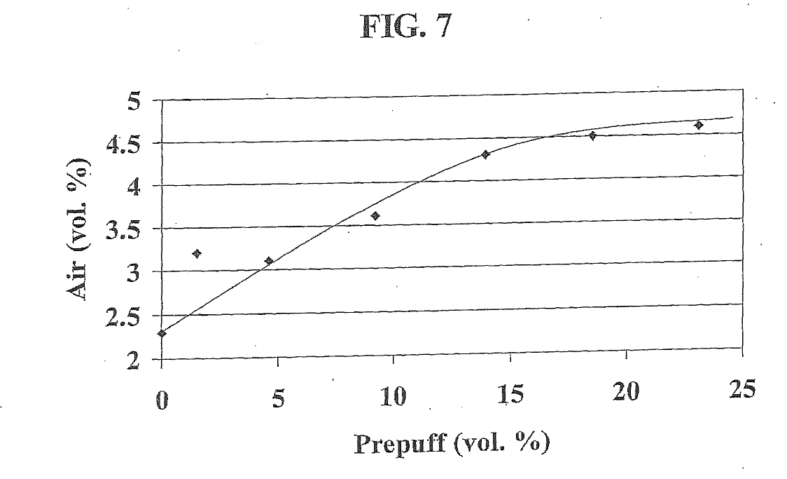

FIG. 7 shows the relationship between the volume percent of prepuff charged to the ready-mix compositions and the volume percent of air measured in the ready-mix compositions. The data show a baseline air content of about 2.3 volume percent with the amount of air increasing as the amount of prepuff in the ready-mix formulation is increased.

### Example 10

The following examples demonstrate the controlled and predictable effect on air content that the expanded polymer particles provide in ready-mix formulations that contains a high range water reducer and that does not contain conventional air entraining admixtures. Polystyrene in unexpanded bead form (EMX-2020) was pre-expanded into prepuff particles having the density shown below. The prepuff particles were formulated into ready-mix compositions, in a 4 ft³ drum-style mixer, containing the components shown in the tables below. The ingredients were combined in the following order: sand (ASTM C33 grade), coarse aggregate, Portland cement (Type 1, Lehigh Cement Company), prepuff, water and high range water reducer (HRWR). Air content was determined by ASTM C231. Slump and/or slump flow values were determined by sampling according to ASTM C 172 and measuring according to ASTM C 143.

| | Sample | | | | | | |
|---|---|---|---|---|---|---|---|
| | AB | AC | AD | AE | AF | AG | AH |
| (lb./yd³) | | | | | | | |
| Cement | 722 | 722 | 722 | 722 | 722 | 722 | 722 |
| Sand | 2291 | 2224 | 2090 | 1890 | 1690 | 1489 | 1289 |
| Prepuff | 0 | 1 | 3 | 6 | 9 | 12 | 15 |
| Coarse Aggregate | 643 | 643 | 643 | 643 | 643 | 643 | 643 |
| HRWR (oz/cwt) | 3.7 | 3.7 | 3.7 | 3.7 | 3.7 | 3.7 | 3.7 |
| Water | 296 | 361 | 361 | 361 | 361 | 361 | 361 |
| Volume Percent | | | | | | | |
| Cement | 13.9 | 13.9 | 13.9 | 13.9 | 13.9 | 13.9 | 13.9 |
| Sand | 52.9 | 47.4 | 48.3 | 43.6 | 39.0 | 34.5 | 29.8 |
| Prepuff | 0 | 1.5 | 4.6 | 9.3 | 13.9 | 18.5 | 23.1 |
| Coarse Aggregate | 15.3 | 15.3 | 15.3 | 15.3 | 15.3 | 15.3 | 15.3 |
| Water | 17.9 | 17.9 | 17.9 | 17.9 | 17.9 | 17.9 | 17.9 |
| Slump (in) | 6.0 | 6.0 | 6.0 | 6.0 | 6.0 | 6.0 | 6.0 |
| Wet Density (pcf) | 140 | 139 | 135 | 129 | 124 | 117 | 108 |
| W/C Ratio | 0.41 | 0.41 | 0.41 | 0.41 | 0.41 | 0.41 | 0.41 |
| Prepuff Density | — | 1.38 | 1.38 | 1.38 | 1.38 | 1.38 | 1.38 |
| (pcf) | | | | | | | |
| Air (vol. %) | 6.0 | 5.8 | 6.1 | 6.4 | 6.6 | 7.4 | 7.8 |

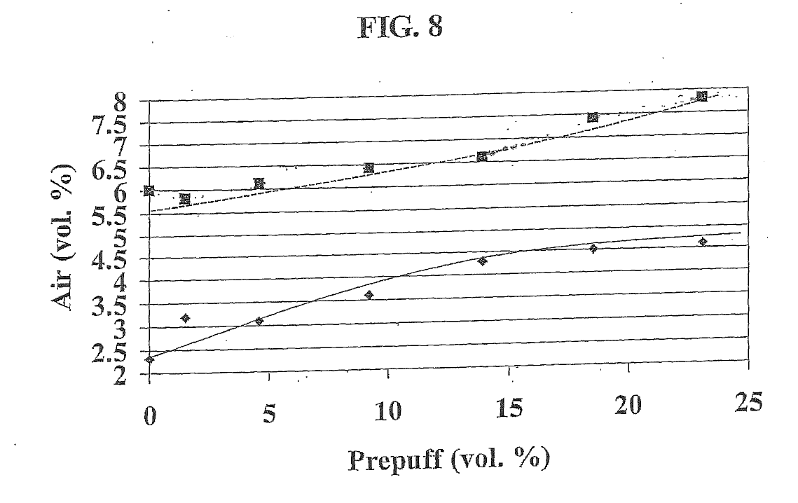

FIG. 8 compares the relationship between the volume percent of prepuff charged to the ready-mix compositions and the volume percent of air measured in the ready-mix compositions when high range water reducers are used (dashed line) and when they are not (Example 19, solid line). The data show a baseline air content of about 6 volume percent, compared with about 2.3% when HRWR is not present, with the amount of air increasing as the amount of prepuff in the ready-mix formulation is increased.

### Example 11

The following examples demonstrate the controlled and predictable effect on air content that the expanded polymer particles provide in precast formulations that contain high range water reducers and that do not contain conventional air entraining admixtures. Polystyrene in unexpanded bead form (EMX-2020) was pre-expanded into prepuff particles having the density shown below. The prepuff particles (added last) were formulated into ready-mix compositions, in a 2.2 ft³ pan-style mixer, (READYMAN® 120, IMER USA Inc., San Francisco, Calif.) containing the components shown in the tables below. The ingredients were combined in the following order: sand (fine, FM=1.74, Lakeland Sand & Gravel, Inc., Hartstown, Pa.), coarse aggregate (89 aggregate), 25% of the water, fly ash (class F, LOI=2.6%), Portland cement (Type 3, Lafarge), remaining water, prepuff, and high range water reducer (HRWR). Air content was determined by ASTM C231. Slump and/or slump flow values were determined by sampling according to ASTM C 172 and measuring according to ASTM C 143.

| | Sample | | | |
|---|---|---|---|---|
| | AI | AJ | AK | AL |
| (lb./yd³) | | | | |
| Cement | 749 | 749 | 749 | 749 |
| Fly Ash | 100 | 100 | 100 | 100 |
| Sand | 1112 | 1154 | 1008 | 891 |
| Prepuff | 0 | 30 | 35 | 39 |
| Coarse Aggregate | 757 | 757 | 757 | 757 |
| HRWR (oz/cwt) | 5.1 | 5.1 | 5.1 | 5.1 |
| Water | 314 | 314 | 314 | 314 |
| Volume Percent | | | | |
| Cement | 18.3 | 14.4 | 14.4 | 14.4 |
| Fly Ash | 3.1 | 2.5 | 2.5 | 2.5 |
| Sand | 32.5 | 26.5 | 23.2 | 20.5 |
| Prepuff | 0 | 20.3 | 23.6 | 26.3 |
| Coarse Aggregate | 22.0 | 17.3 | 17.3 | 17.3 |
| Water | 24.1 | 19.0 | 19.0 | 19.0 |
| Slump/flow (in) | 4.5 | 4.7 | 9.5 | 19.0 |
| Wet Density (pcf) | 143 | 116 | 109 | 105 |
| W/C Ratio | 0.37 | 0.37 | 0.37 | 0.37 |
| Prepuff Density (pcf) | 0 | 3.46 | 3.46 | 3.46 |
| Air (vol. %) | 3.2 | 6.2 | 6.8 | 7.0 |
| Compressive | | | | |
| Strength | | | | |
| 7-day | 9204 | 4424 | 3538 | 3134 |
| 28-day | 11302 | 5078 | 4227 | 3705 |

The data show a baseline air content for this precast formulation of about 3.2 volume percent with the amount of air increasing as the amount of prepuff in the precast formulation is increased.

### Example 12

The following examples demonstrate the controlled and predictable effect on air content that the expanded polymer particles provide in precast formulations that contain high range water reducers and that do not contain conventional air entraining admixtures. Polystyrene in unexpanded bead form (EMX-2020) was pre-expanded into prepuff particles having the density shown below. The prepuff particles (added last) were formulated into ready-mix compositions, in a 2.2 ft³ pan-style mixer, (READYMAN® 120, IMER USA Inc., San Francisco, Calif.) containing the components shown in the tables below. The ingredients were combined in the following order: sand (fine, FM=1.74, Lakeland), coarse aggregate (89 aggregate), 25% of the water, fly ash (class F, LOI=2.6%), Portland cement (Type 3, Lafarge), remaining water, prepuff, and high range water reducer (HRWR). Air content was determined by ASTM C231. Slump and/or slump flow values were determined by sampling according to ASTM C 172 and measuring according to ASTM C 143.

| | Sample | | | |
|---|---|---|---|---|
| | AM | AN | AO | AP |
| (lb./yd³) | | | | |
| Cement | 749 | 749 | 749 | 749 |
| Fly Ash | 100 | 100 | 100 | 100 |
| Sand | 1112 | 1388 | 1241 | 1066 |
| Prepuff | 0 | 22 | 27 | 33 |
| Coarse Aggregate | 757 | 757 | 757 | 757 |
| HRWR (ml) | 75 | 75 | 75 | 75 |
| Water | 314 | 314 | 314 | 314 |
| Volume Percent | | | | |
| Cement | 18.3 | 14.4 | 14.4 | 14.4 |
| Fly Ash | 3.1 | 2.5 | 2.5 | 2.5 |
| Sand | 32.5 | 31.9 | 28.6 | 24.6 |
| Prepuff | 0 | 14.8 | 18.2 | 22.2 |
| Coarse Aggregate | 22.0 | 17.3 | 17.3 | 17.3 |
| Water | 24.1 | 19.0 | 19.0 | 19.0 |
| Slump Flow (in) | 20 | 16.5 | 16.5 | 18 |
| Wet Density (pcf) | 143 | 122 | 116 | 108 |
| W/C Ratio | 0.37 | 0.37 | 0.37 | 0.37 |
| Prepuff Density (pcf) | 0 | 3.46 | 3.46 | 3.46 |
| Air (vol. %) | 1.7 | 3.9 | 4.9 | 5.7 |
| Compressive Strength | | | | |
| 7-day | 9329 | 5221 | 4387 | 3529 |
| 28-day | 11197 | 6087 | 5125 | 4168 |

The data show a baseline air content for this precast formulation of about 1.7 volume percent with the amount of air increasing as the amount of prepuff in the precast formulation is increased. When compared with Example 11, the data demonstrate changes in absolute values that occur due to lot to lot variations in starting materials and the effect of the higher flow values on measured air content.

### Example 13

The following examples demonstrate the controlled and predictable effect on air content that the expanded polymer particles provide in ready-mix formulations that contain conventional air entraining admixtures and high range water reducers (HRWR). Polystyrene in unexpanded bead form (EMX-2020) was pre-expanded into prepuff particles having the density shown below. The prepuff particles were formulated into ready-mix compositions, in a 4 ft³ drum-style mixer, containing the components shown in the tables below. The ingredients were combined in the following order: sand (ASTM C33 grade), coarse aggregate, Portland cement (Type 1, Lehigh Cement Company), prepuff, water and high range water reducer (HRWR). Air content was determined by ASTM C231. Slump and/or slump flow values were determined by sampling according to ASTM C 172 and measuring according to ASTM C 143.

| | Sample | | |
|---|---|---|---|
| | AQ | AR | AS |
| (lb./yd³) | | | |
| Cement | 722 | 722 | 722 |
| Sand | 1565 | 1450 | 1450 |
| Prepuff | 10.6 | 10.6 | 10.6 |
| Coarse Aggregate | 646 | 646 | 646 |
| air entraining admixture | 0 | 0.3 | 0.3 |
| (oz/cwt) | | | |
| HRWR (oz/cwt) | 2 | 2 | 1.2 |
| Water | 296 | 296 | 296 |
| Volume Percent | | | |
| Cement | 13.9 | 14.3 | 14.3 |
| Sand | 36.5 | 34.7 | 34.7 |
| Prepuff | 16.4 | 16.9 | 16.9 |
| Coarse Aggregate | 15.3 | 15.7 | 15.7 |
| Water | 17.9 | 18.4 | 18.4 |
| Slump (in) | 5.0 | 7.0 | 5.0 |
| Wet Density (pcf) | 120 | 113 | 115 |
| W/C Ratio | 0.41 | 0.41 | 0.41 |
| Prepuff Density (pcf) | 1.38 | 1.38 | 1.38 |
| Air (vol. %) | 5.3 | 9.1 | 7.8 |
| Compressive Strength | | | |
| 7-day | 2728 | 2034 | 2192 |
| 28-day | 3406 | 2747 | 3001 |

The data show the additive effect of combining the prepuff particles of the invention with conventional air entraining admixtures in ready-mix formulations.

### Example 14

The following examples demonstrate the controlled and predictable effect on air content that the present expanded polymer particles provide in ready-mix formulations compared with the high and unpredictable amount of air in ready-mix formulations that utilize micronized EPS. Polystyrene in unexpanded bead form (EMX-202) was pre-expanded into prepuff particles having the density shown below. The prepuff particles were formulated into ready-mix compositions, in a 4 ft³ drum-style mixer, containing the components shown in the tables below. The ingredients were combined in the following order: sand (ASTM C33 grade), coarse aggregate, Portland cement (Type 1, Lehigh Cement Company), prepuff, water and high range water reducer (HRWR). Air content was determined by ASTM C231.

The surface area of prepuff particles according to the invention and micronized EPS (Premier Industries, Tacoma. WA) was determined via multipoint surface area methods using Krypton gas. This method provides a BET surface area measurement of the samples determined by the amount of Krypton gas adsorption on the EPS surface. As the table below shows, the surface area of the present expanded polymer particles was below the measurement limit for the test, while a significantly larger and varying surface area was measured for the micronized samples.

| | Density | Surface Area | |
|---|---|---|---|
| | pcf | m²/g | SpecGravity |
| F271 | 1.44 | — | 0.0386 |
| F271 | 3.46 | — | 0.0968 |
| Micronized A | 0.78 | 3.2683 | 0.0678 |
| Micronized B | 0.80 | 3.0313 | 0.0706 |

Slump and/or slump flow values were determined by sampling according to ASTM C 172 and measuring according to ASTM C 143.

| | Sample | | | |
|---|---|---|---|---|
| | AT | AU | AV | AW |
| (lb./yd³) | | | | |
| Cement | 722 | 722 | 722 | 722 |
| Sand | 1463 | 1463 | 1528 | 1497 |
| Prepuff | — | — | 9.9 | 9.2 |
| Micronized EPS | 8.3 | 8.3 | — | — |
| Coarse Aggregate | 643 | 643 | 643 | 643 |
| Water | 296 | 307 | 307 | |
| Volume Percent | | | | |
| Cement | 13.9 | 13.9 | 13.9 | 13.9 |
| Sand | 33.8 | 33.8 | 35.3 | 34.6 |
| Prepuff | — | — | 15.0 | 14.0 |
| Micronized EPS | 12.5 | 12.5 | — | — |
| Coarse Aggregate | 15.3 | 15.3 | 15.3 | 15.3 |
| Water | 24.5 | 24.5 | 20.5 | 22.2 |
| Slump (in) | 4.2 | 5.0 | 2.5 | 8.7 |
| Wet Density (pcf) | 117 | 116 | 123 | 122 |
| W/C Ratio | 0.56 | 0.56 | 0.47 | 0.51 |
| Prepuff Density (pcf) | 1.14 | 1.14 | 1.44 | 1.44 |
| Air (vol. %) | 10.3 | 10.4 | 4.4 | 3.4 |
| Compressive Strength | | | | |
| 7-day | 1226 | 1283 | 2543 | 2113 |
| 28-day | 1748 | 1871 | 3655 | 3098 |

The data show the problems encountered when micronized EPS is used in ready-mix formulations. The exposed cellular structure of the micronized EPS greatly increases the water demand in the formulation requiring higher water to cement ratios in order to provide a workable material (adequate slump). The increased water demand and higher air content result in a ready-mix formulation demonstrating considerably lower strength.

### Example 15

The following examples demonstrate the controlled and predictable effect on air content that the present expanded polymer particles provide in ready-mix formulations compared with the high and unpredictable amount of air in ready-mix formulations that utilize micronized EPS. Polystyrene in unexpanded bead form (EMX-202) was pre-expanded into prepuff particles having the density shown below. The prepuff particles were formulated into ready-mix compositions, in a 4 ft³ drum-style mixer, containing the components shown in the tables below. The ingredients were combined in the following order: sand (ASTM C33 grade), coarse aggregate, Portland cement (Type 1, Lehigh Cement Company), prepuff, water and high range water reducer (HRWR). Air content was determined by ASTM C231. The formulas were adjusted to obtain comparable wet density and slump values between the formulations. Air content was determined by ASTM C231. Slump and/or slump flow values were determined by sampling according to ASTM C 172 and measuring according to ASTM C 143.

Sample

| | AX | AY |
|---|---|---|
| (lb./yd³) | | |
| Cement | 722 | 722 |
| Sand | 1485 | 1496 |
| Prepuff | — | 10.4 |
| Micronized EPS | 7.7 | — |
| Coarse Aggregate | 643 | 643 |
| Water | 383 | 339 |
| Volume Percent | | |
| Cement | 13.9 | 13.9 |
| Sand | 34.3 | 34.5 |
| Prepuff | — | 15.7 |
| Micronized EPS | 13.4 | — |
| Coarse Aggregate | 15.3 | 15.3 |
| Water | 23.2 | 20.5 |
| Slump (in) | 3.25 | 3.25 |
| Wet Density (pcf) | 119 | 121 |
| W/C Ratio | 0.53 | 0.47 |
| Prepuff Density (pcf) | 1.26 | 1.44 |
| Air (vol. %) | 10.6 | 5.5 |
| Compressive Strength | | |
| 7-day | 1714 | 2611 |
| 28-day | 2345 | 3279 |

The data show the problems encountered when micronized EPS is used in ready-mix formulations. The exposed cellular structure of the micronized EPS greatly increases the water demand in the formulation requiring higher water to cement ratios in order to provide a workable material (adequate slump). The increased water demand and higher air content result in a ready-mix formulation demonstrating considerably lower strength.

### Example 16

The following examples demonstrate the controlled and predictable effect on air content that the present expanded polymer particles provide in ready-mix formulations compared with the high and unpredictable amount of air in ready-mix formulations that utilize micronized EPS. Polystyrene in unexpanded bead form (EMX-2020) was pre-expanded into prepuff particles having the density shown below. The prepuff particles were formulated into ready-mix compositions, in a 4 ft³ drum-style mixer containing the components shown in the tables below. The ingredients were combined in the following order: sand (ASTM C33 grade), coarse aggregate, Portland cement (Type 1, Lehigh Cement Company), prepuff, water and high range water reducer (HRWR). Air content was determined by ASTM C231. The formulas were adjusted to obtain comparable water to cement ratios between the formulations. Air content was determined by ASTM C231. Slump and/or slump flow values were determined by sampling according to ASTM C 172 and measuring according to ASTM C 143.

Sample

| | BA | BB |
|---|---|---|
| (lb./yd³) | | |
| Cement | 722 | 722 |
| Sand | 1506 | 1505 |
| Prepuff | — | 9.4 |
| Micronized EPS | 8.2 | — |
| Coarse Aggregate | 643 | 643 |
| Water | 361 | 361 |
| Volume Percent | | |
| Cement | 13.9 | 13.9 |
| Sand | 34.8 | 34.8 |
| Prepuff | — | 14.2 |
| Micronized EPS | 14.2 | — |
| Coarse Aggregate | 15.3 | 15.3 |
| Water | 21.8 | 21.8 |
| Slump (in) | 2.5 | 7.5 |
| Wet Density (pcf) | 117 | 120 |
| W/C Ratio | 0.50 | 0.50 |
| Prepuff Density (pcf) | 1.26 | 1.44 |
| Air (vol. %) | 10.6 | 4.1 |
| Compressive Strength | | |
| 7-day | 1752 | 2482 |
| 28-day | 2229 | 3302 |

The data show the problems encountered when micronized EPS is used in ready-mix formulations. The exposed cellular structure of the micronized EPS greatly increases the water demand in the formulation resulting in a significantly lower slump in the micronized EPS formulation. The increased water demand and higher air content result in a ready-mix formulation demonstrating considerably lower strength.

### Example 17

The following examples demonstrate the controlled and predictable effect on air content that the present expanded polymer particles provide in concrete formulations and the benefit the particles provide for freeze-thaw and durability properties of the resulting concrete. Polystyrene in unexpanded bead form (EMX-2020) was pre-expanded into prepuff particles having the density shown below. The prepuff particles were formulated into concrete compositions, in a 2.2 ft³ pan-style mixer (sample BC, prepuff added last) or 4 ft³ drum-style mixer (samples BD and BE) containing the components shown in the tables below. The ingredients were combined in the following order for samples BD and BE (Ready Mix): sand (ASTM C33 grade), coarse aggregate (No. 67 river rock), Portland cement (Type 1, Lehigh), prepuff, water, high range water reducer (HRWR) and air entraining admixture for sample BE. For sample BC (Precast), the ingredients were combined in the following order: sand (fine, FM=1.74, Lakeland), coarse aggregate (89 granite), 25% of the water, fly ash (class F, LOI=2.6%), Portland cement (Type III, Lafarge), remaining water, prepuff and high range water reducer (HRWR). Air content was determined by ASTM C231. Slump and/or slump flow values were determined by sampling according to ASTM C 172 and measuring according to ASTM C 143. Durability was determined after 300 freeze-thaw cycles according to Procedure A of ASTM C666 “Standard Test Method for Resistance to Rapid Freezing and Thawing”.

| | Sample | | |
|---|---|---|---|
| | BC | BD | BE |
| (lb./yd³) | | | |
| Cement | 749 | 722 | 722 |
| Fly Ash | 100 | — | — |
| Sand | 1183 | 1559 | 1450 |
| Prepuff | 31.8 | 9.4 | 10.7 |
| Coarse Aggregate | 756 | 647 | 646 |
| Water | 285 | 303 | 296 |
| HRWR (oz/cw) | 11 | 5 | 1.6 |
| air entraining admixture | — | — | 0.3 |
| (oz/cwt) | | | |
| Volume Percent | | | |
| Cement | 14.3 | 14.0 | 14.3 |
| Fly Ash | 2.7 | — | — |
| Sand | 27.2 | 37.2 | 34.7 |
| Prepuff | 21.1 | 15.2 | 16.9 |
| Coarse Aggregate | 17.4 | 15.2 | 15.7 |
| Water | 17.3 | 18.4 | 18.4 |
| Slump/Flow (in) | 23.5 | 6.7 | 7.0 |
| Wet Density (pcf) | 116 | 125 | 113 |
| W/C Ratio | 0.34 | 0.42 | 0.41 |
| Prepuff Density (pcf) | 3.43 | 1.4 | 1.4 |
| Air (vol. %) | 3.4 | 5.6 | 9.1 |
| Compressive Strength | | | |
| 7-day | 4400 | 3953 | 2035 |
| 28-day | — | 4640 | 2747 |
| ASTM C666 (300 cycles) | | | |
| Weight Loss (%) | 0.04 | 0.02 | 0.02 |
| Length, Exp. (%) | 0.02 | 0.01 | 0.01 |
| RDM (%) | 96 | 98 | 98 |

The data demonstrate the excellent freeze-thaw and durability characteristics of concrete formulations made according to the invention. While an RDM value of greater than 80% is considered to be a good result, the concrete formulation samples containing the present expanded particles demonstrate an RDM value of 96% and 98%, which correlates to excellent freeze-thaw and durability properties in the concrete.

In Section 4.2 “Freezing and thawing exposures” of ACI-318 (2005) Building Code and Commentary indicates that it is indicated that in order to get acceptable durability for normal weight and lightweight concrete using ⅜ inch 89 granite as coarse aggregate the air content must be between 6% and 7.5%±1.5%. It was very surprising therefore to get the result for sample BC, where excellent durability was observed (RDM of 96%) using ⅜ inch 89 granite as coarse aggregate when the measured air content was 3.4%. This example further demonstrates the unique and unexpected durability properties of concrete containing prepuff particles according to the present invention.

### Example 18

The following examples demonstrate the controlled and predictable effect on air content that the expanded polymer particles provide in ready-mix formulations that contain high LOI class F fly ash (samples BJ and BK). Polystyrene in unexpanded bead form (EMX-2020) was pre-expanded into prepuff particles having the density shown below. The prepuff particles were formulated into ready-mix compositions, in a 4 ft³ drum-style mixer containing the components shown in the tables below. The ingredients were combined in the following order: sand (ASTM C33 grade), coarse aggregate (67 limestone), 50% of the water, Portland cement (Type 1, Lehigh Cement Company), fly ash (class F), 25% of the water, prepuff and the remaining 25% of the water. Air content was determined by ASTM C231. Slump and/or slump flow values were determined by sampling according to ASTM C 172 and measuring according to ASTM C 143. Samples BF, BH and BJ are compositions according to the invention. Samples BG, BI and BK are comparable samples showing the effect of the LOI in fly ash on air content in the concrete

| | Sample | | | | | |
|---|---|---|---|---|---|---|
| | BF | BG | BH | BI | BJ | BK |
| (lb./yd³) | | Prior art | | Prior art | | Prior art |
| Cement | 637 | 637 | 722 | 722 | 637 | 637 |
| Sand | 1526 | 934 | 1525 | 965 | 1525 | 943 |
| Fly Ash | 85 | 85 | — | — | 85 | 85 |
| -LOI | 2.6% | 2.6% | — | — | 12% | 12% |
| Prepuff | 11.2 | — | 11.7 | — | 11.3 | — |
| Prepuff (vol. | 17 | — | 17 | — | 17 | — |
| %) | | | | | | |
| Coarse | 686 | 2057 | 686 | 2057 | 686 | 2057 |
| Aggregate | | | | | | |
| Water | 296 | 296 | 296 | 296 | 296 | 296 |
| Slump (in) | 4.5 | 7.5 | 4.0 | 6 | 3.8 | 4.25 |
| Wet Density | 121 | 148 | 119 | 149 | 120 | 148 |
| (pcf) | | | | | | |
| W/C Ratio | 0.41 | 0.41 | 0.41 | 0.41 | 0.41 | 0.41 |
| Prepuff Density | 1.44 | — | 1.44 | — | 1.44 | — |
| (pcf) | | | | | | |
| Air (vol. %) | 5.5 | 1.5 | 5.6 | 1.4 | 5.6 | 1.4 |
| Compressive | | | | | | |
| Strength | | | | | | |
| 7-day | 2761 | 5120 | 2637 | 5520 | 2506 | 5240 |
| 28-day | 3420 | 6657 | 3370 | 7070 | 3370 | 7026 |

The data show the improved air content in ready-mix formulations that contain the present expanded polymer particles, especially when high LOI fly ash is used in the concrete formulation.

### Example 19

The following examples demonstrate the controlled and predictable effect on air content that the expanded polymer particles provide in ready-mix formulations that contain high LOI class F fly ash. Polystyrene in unexpanded bead form (EMX-2020) was pre-expanded into prepuff particles having the density shown below. The prepuff particles were formulated into ready-mix compositions, in a drum-style mixer containing the components shown in the tables below. The ingredients were combined in the following order: sand (ASTM C33 grade), coarse aggregate (mixture of 57 and 89 limestone), 50% of the water, Portland cement (Type 1, Lehigh Cement Company), fly ash (class F), 25% of the water, prepuff and the remaining 25% of the water. Air content was determined by ASTM C231. Slump and/or slump flow values were determined by sampling according to ASTM C 172 and measuring according to ASTM C 143.

| | Sample | | | |
|---|---|---|---|---|
| | BL | BM | BN | BO |
| (lb./yd³) | | | | |
| Cement | 578 | 578 | 578 | 578 |
| Sand | 1514 | 1519 | 1517 | 1515 |
| Fly Ash | 144 | 140 | 142 | 143 |
| - LOI | <0.1% | 6.2% | 12% | 2.2% |
| Prepuff | 12.7 | 12.7 | 12.4 | 12.6 |
| Prepuff (vol. %) | 18.8 | 18.7 | 18.8 | 18.4 |
| Coarse Aggregate | 695 | 695 | 695 | 695 |
| Water | 296 | 314 | 314 | 296 |
| air entraining | 3.2 | 38 | 76 | 38 |
| admixture (ml/1.5 ft³) | | | | |
| Slump (in) | 6 | 2 | 8 | 2.8 |
| Wet Density (pcf) | 120 | 120 | 118 | 117 |
| W/C Ratio | 0.41 | 0.44 | 0.44 | 0.41 |
| Prepuff Density (pcf) | 1.4 | 1.4 | 1.4 | 1.4 |
| Air (vol. %) | 8.2 | 6.3 | 7.3 | 7.0 |
| Compressive Strength | | | | |
| 7-day | 2098 | 2396 | 2044 | 2264 |
| 28-day | 2643 | 2829 | 2832 | 2821 |

The data show the air content control in ready-mix formulations that is obtained when present expanded polymer particles are used in the formulation, regardless of the LOI value of the fly ash that is used.

### Example 20

The following examples demonstrate the controlled and predictable effect on air content that the expanded polymer particles provide in ready-mix and precast formulations. Polystyrene in unexpanded bead form (EMX-2020) was pre-expanded into prepuff particles having the density shown below. The prepuff particles were formulated into concrete compositions, in a 2.2 ft³ pan-style mixer (samples BP and BR) or a 4 ft³ drum-style mixer (sample BQ) containing the components shown in the tables below. The ingredients were combined in the following order: sand (ASTM C33 grade), coarse aggregate (67 limestone [BQ] and 89 granite [BR]), 50% of the water, Portland cement (Type 3, Lafarge [BP and BR], Type 1, Lehigh [BQ]), 25% of the water, prepuff, high range water reducer (HRWR) and the remaining 25% of the water. Air content was determined by ASTM C231. Slump and/or slump flow values were determined by sampling according to ASTM C 172 and measuring according to ASTM C 143.

| | Sample | | |
|---|---|---|---|
| | BP | BQ | BR |
| (lb./yd³) | | | |
| Cement | 865 | 722 | 749 |
| Sand | 1182 | 1525 | 1178 |
| Fly Ash | — | — | 100 |
| - LOI | — | — | <0.1% |
| Prepuff | 53.9 | 11.7 | 31.0 |
| Prepuff (vol. %) | 35 | 17 | 20 |
| Coarse Aggregate | — | 686 | 757 |
| Water | 329 | 296 | 289 |
| HRWR (ml/1.5 ft³) | 113 | 37 | 111 |
| Flow (in) | 18.5 | — | 16.5 |
| Slump (in) | — | 2.5 | — |
| Wet Density (pcf) | 85.6 | 124 | 112 |
| W/C Ratio | 0.38 | 0.41 | 0.34 |
| Prepuff Density (pcf) | 3.5 | 1.4 | 3.5 |
| Air (vol. %) | 7.8 | 5.8 | 6.6 |
| Compressive Strength | | | |
| 7-day | 2868 | 2973 | 4218 |
| 28-day | 3218 | 3741 | 5011 |

The data show the air content control in concrete formulations that is obtained when the present expanded polymer particles are used in the formulation.

As indicated above, it is generally accepted the air void characteristics of concrete systems that demonstrate good durability have an average maximum distance between air voids of less than 0.008 inches (0.2 mm), which is often referred to as the “spacing factor” and a “specific surface area” (average surface area of the air voids) of at least 600 in² per cubic inch (23.6 mm²/mm³). Further, the number of voids per linear inch (25 mm) of traverse is typically greater than the numerical value of the percentage of air in the concrete. These values are indicated below as conventional values.

In samples BQ, BP and BR, an air-void system analysis was conducted according to ASTM C 457-06 “Modified Point-Count Method” in order to better characterize the nature of the air content in these concrete formulations. The data is summarized in the table below.

| | Sample | | | Conventional |
|---|---|---|---|---|
| | BP | BQ | BR | Values |
| Spacing Factor | | | | |
| Inches | 0.023 | 0.021 | 0.015 | 0.008 |
| mm | 9 | 8.3 | 5.9 | 0.2 |
| Specific Surface Area | | | | |
| in²/in² | 222 | 252 | 390 | 600 |
| mm²/mm³ | 8.7 | 9.9 | 15.3 | 23.6 |
| Number of voids per | 3.3 | 2.8 | 4.2 | Greater than |
| inch | | | | percentage of |
| | | | | air |

In all cases and in all categories, the concrete containing prepuff particles according to the present invention have an entrained air profile that is very different from what is conventionally expected to be required to obtain durable concrete. It was very surprising to observe, therefore, the excellent durability results for these formulations as shown in Example 21 below.

### Example 21

The following examples demonstrate the controlled and predictable effect on air content that the present expanded polymer particles provide in concrete formulations and the benefit the particles provide for freeze-thaw and durability properties of the resulting concrete. Polystyrene in unexpanded bead form (EMX-2020) was pre-expanded into prepuff particles having the density shown below. The prepuff particles were formulated into concrete compositions, in a 2.2 ft³ pan-style mixer (samples BT and BW) or a 4 ft³ drum-style mixer (samples BU and BV) containing the components shown in the tables below. The ingredients were combined in the following order for samples BU and BV (Ready Mix): sand (ASTM C33 grade), coarse aggregate (No. 67 river rock), Portland cement (Type 1, Lehigh), prepuff, water, and high range water reducer (HRWR). For samples BT and BW (Precast), the ingredients were combined in the following order: sand (fine, FM=1.74, Lakeland), coarse aggregate (89 granite), 25% of the water, fly ash (class F, LOI=2.6%), Portland cement (Type III, Lafarge), remaining water and high range water, prepuff reducer (HRWR). Air content was determined by ASTM C231. Slump and/or slump flow values were determined by sampling according to ASTM C 172 and measuring according to ASTM C 143. Durability was determined after 300 freeze-thaw cycles according to Procedure A of ASTM C666 “Standard Test Method for Resistance to Rapid Freezing and Thawing”.

| | Sample | | | |
|---|---|---|---|---|
| | BT | BU | BV | BW |
| (lb./yd³) | | | | |
| Cement | 749 | 722 | 722 | 865 |
| Fly Ash | 100 | — | — | — |
| Sand | 1178 | 1525 | 1799 | 1182 |
| Prepuff | 31.0 | 11.7 | 7.5 | 53.9 |
| Prepuff (vol. %) | 20 | 17 | 11 | 35 |
| Coarse Aggregate | 757 | 686 | 686 | — |
| Water | 289 | 296 | 296 | 329 |
| HRWR (ml/1.25 ft³) | 128 | 48 | 16 | 128 |
| Slump/Flow (in) | 24 | 2.75 | 6 | 20.5 |
| Wet Density (pcf) | 118 | 122 | 130 | 88 |
| W/C Ratio | 0.34 | 0.41 | 0.41 | 0.38 |
| Prepuff Density (pcf) | 3.4 | 1.4 | 1.4 | 3.4 |
| Air (vol. %) | 4.9 | 6.6 | 6.8 | 6.2 |
| Compressive Strength | | | | |
| 7-day | 4919 | 2932 | 4181 | 3177 |
| 28-day | 5214 | 3537 | 4986 | 3453 |
| ASTM C666 (300 cycles) | | | | |
| RDM (%) | 98 | 91 | 93 | 100 |

Compared to Example 20, sample BT is similar to sample BR, sample BU is similar to sample BQ and sample BW is similar to sample BP. As indicated above, it was very surprising to observe the excellent durability results for these formulations compared to what would be expected based on conventional air entrained concrete.

Petrographic examination of these samples indicated that where microcracks were observed in the samples, they were not initiated at the prepuff particles. The observed microcracks were generally attributed to popouts associated with fine aggregate particles.

The data demonstrate the excellent freeze-thaw and durability characteristics of concrete formulations made according to the invention. While an RDM value of greater than 80% is considered to be a good result, the concrete formulation samples containing the present expanded particles demonstrate RDM values of 91% to 100%, which correlates to excellent freeze-thaw and durability properties in the concrete.

### Example 22

The following examples demonstrate the controlled and predictable effect on air content that the present expanded polymer particles provide in concrete formulations and the benefit the particles provide for freeze-thaw and durability properties of the resulting concrete. Polystyrene in unexpanded bead form (EMX-2020) was pre-expanded into prepuff particles having the density shown below. The prepuff particles were formulated into concrete compositions, in a 2.2 ft³ pan-style mixer (samples CA and CB, prepuff added last) or a 4 ft³ drum-style mixer (samples CD and CE) containing the components shown in the tables below. The ingredients were combined in the following order for samples CD and CE (Ready Mix): sand (ASTM C33 grade), coarse aggregate (No. 67 river rock), Portland cement (Type 1, Lehigh), prepuff, water, and high range water reducer (HRWR) and air entraining admixture. For samples CA and CB (Precast), the ingredients were combined in the following order: prepuff, sand (fine, FM=1.74, Lakeland), coarse aggregate (89 granite), 25% of the water, fly ash (class F, LOI=2.6%), Portland cement (Type III, Lafarge), remaining water and high range water reducer (HRWR) and air entraining admixture. Air content was determined by ASTM C231. Slump and/or slump flow values were determined by sampling according to ASTM C 172 and measuring according to ASTM C 143. Durability was determined after 300 freeze-thaw cycles according to Procedure A of ASTM C666 “Standard Test Method for Resistance to Rapid Freezing and Thawing”.

| | Sample | | | |
|---|---|---|---|---|
| | CA | CB | CD | CE |
| (lb./yd³) | | | | |
| Cement | 749 | 865 | 722 | 722 |
| Fly Ash | 100 | — | — | — |
| Sand | 1183 | 1190 | 1802 | 1528 |
| Prepuff | 26 | 46 | 4.8 | 9 |
| Prepuff (vol. %) | 17 | 30 | 7 | 13 |
| Coarse Aggregate | 757 | — | 686 | 686 |
| Water | 289 | 329 | 296 | 296 |
| HRWR (ml//1.25 ft³) | 128 | 128 | 16 | 16 |
| Air Entraining Admixture | 0.5 | 0.5 | 0.5 | 0.5 |
| (oz/cwt) | | | | |
| Slump/Flow (in) | 21.5 | 18 | 7 | 6 |
| Wet Density (pcf) | 112 | 87 | 127 | 121 |
| W/C Ratio | 0.34 | 0.38 | 0.41 | 0.41 |
| Prepuff Density (pcf) | 3.4 | 3.4 | 1.4 | 1.4 |
| Air (vol. %) | 8.3 | 13 | 10.5 | 8.4 |
| Compressive Strength | | | | |
| 7-day | 4376 | 2785 | 3155 | 2414 |
| 28-day | 5119 | 3322 | 4198 | 3238 |
| ASTM C666 (300 cycles) | | | | |
| RDM (%) | 99 | 101 | 97 | 100 |

The data demonstrate the excellent freeze-thaw and durability characteristics of concrete formulations made according to the invention. While an RDM value of greater than 80% is considered to be a good result, the concrete formulation samples containing the present expanded particles demonstrate RDM values of 97% to 101%, which correlates to excellent freeze-thaw and durability properties in the concrete.

### Example 23

The following examples demonstrate the controlled and predictable effect on air content that the present expanded polymer particles provide in concrete formulations and the benefit the particles provide for freeze-thaw and durability properties of the resulting concrete. Polystyrene in unexpanded bead form (EMX-2020) was pre-expanded into prepuff particles having the density shown below. The prepuff particles were formulated into concrete compositions, in a 4 ft³ drum-style mixer containing the components shown in the tables below. The ingredients were combined in the following order: sand (ASTM C33 grade), coarse aggregate (No. 67 river rock), Portland cement (Type 1, Lehigh), prepuff, water, and high range water reducer (HRWR) and air entraining admixture. Air content was determined by ASTM C231. Slump and/or slump flow values were determined by sampling according to ASTM C 172 and measuring according to ASTM C 143. Durability was determined after 300 freeze-thaw cycles according to Procedure A of ASTM C666 “Standard Test Method for Resistance to Rapid Freezing and Thawing”.

| | Sample | | | | | | | |
|---|---|---|---|---|---|---|---|---|
| | CF | CG | CH | CI | CJ | CK | CL | CM |
| (lb./yd³) | Prior | Prior | | | | | | |
| | art | art | | | | | | |
| Cement | 564 | 564 | 564 | 564 | 564 | 564 | 564 | 564 |
| Sand | 1347 | 1240 | 1135 | 994 | 1135 | 994 | 1135 | 1065 |
| Prepuff | — | — | 7.7 | 12.9 | 10.7 | 17.8 | 15.5 | 20.6 |
| Prepuff (vol. %) | — | — | 11 | 18.5 | 11 | 18.5 | 11 | 14.8 |
| Coarse Aggregate | 1836 | 1810 | 1547 | 1354 | 1547 | 1354 | 1547 | 1451 |
| Water | 282 | 282 | 282 | 282 | 282 | 282 | 282 | 282 |
| HRWR (ml/1.5 ft³) | 45 | 35 | 35 | 33 | 38 | 35 | 35 | 35 |
| Air Entraining | — | 0.5 | — | — | — | — | — | — |
| admixture (oz/cwt) | | | | | | | | |
| Slump (in) | 2.5 | 5.25 | 4.5 | 6 | 5 | 3 | 6.5 | 2.5 |
| Wet Density (pcf) | 150.0 | 145 | 134 | 121 | 134 | 120 | 134 | 126 |
| W/C Ratio | 0.5 | 0.5 | 0.5 | 0.5 | 0.5 | 0.5 | 0.5 | 0.5 |
| Prepuff Density | — | — | 1.5 | 1.5 | 2.1 | 2.1 | 3.3 | 3.3 |
| (pcf) | | | | | | | | |
| Air (vol. %) | 2.1 | 5.6 | 3.4 | 5.4 | 3.4 | 5.2 | 3.1 | 4.5 |
| Compressive | | | | | | | | |
| Strength | | | | | | | | |
| 7-day | 4831 | 4305 | 2407 | 1696 | 2627 | 1690 | 2730 | 2428 |
| 28-day | 6142 | 5445 | 3242 | 2260 | 3471 | 2264 | 3595 | 3149 |
| ASTM C666 | | | | | | | | |
| (300 cycles) | | | | | | | | |
| RDM (%) | 0 | 95 | 62 | 70 | 62 | 81 | 53 | 81 |

The data demonstrate the effect of the volume percentage of prepuff particles in the present concrete formulations on durability and demonstrate that in these particular concrete formulations having a relatively high water to cement ratio and the indicated cement loadings, about 12 volume percent of prepuff particles are required to obtain an RDM of at least 70% using Procedure A of ASTM C666. Sample CF is a conventional concrete formulation with no air entraining admixtures and demonstrates the poor durability of such formulations. Sample CG is a conventional concrete formulation containing air entraining admixtures and demonstrates the good durability of these types of formulations when properly prepared.

The data demonstrate the desirable combination of predictable concrete density, predictable strength and predictable durability that can be obtained with the concrete formulations according to the invention.

The present invention has been described with reference to specific details of particular embodiments thereof. It is not intended that such details be regarded as limitations upon the scope of the invention except insofar as and to the extent that they are included in the accompanying claims.

1. A method of improving the durability of concrete formulations comprising:
combining cement, water, and optionally supplementary cementitious materials, aggregates, admixtures, and/or additives to form an aqueous cement mixture having a water to cementitious ratio of from 0.25 to 0.6;
adding prepuff particles to the cement mixture to form a concrete formulation containing from 6 to 40 volume percent of prepuff particles, wherein the prepuff particles have an average particle diameter of from 0.2 mm to 3 mm, a bulk density of from 0.015 g/cc to 0.35 g/cc, an aspect ratio of from 1 to 3, and a smooth continuous outer surface; and
curing the concrete formulation to a hardened mass having a relative dynamic modulus (RDM) of at least 70% determined according to Procedure A of ASTM C666 (2003).

2. The method according to claim 1, wherein the concrete formulations comprise fly ash having an LOI determined according to ASTM C 618 of greater than 6%.

3. The method according to claim 1, wherein after the concrete has cured and hardened for 28 days, has a compressive strength of at least 1400 psi as tested according to ASTM C39.

4. The method according to claim 1, wherein the supplementary cementitious materials are one or more selected from the group consisting of type C fly ash, type F fly ash, silica fume, micronized silica, volcanic ash, calcined clay, metakaolin clay and ground granulated blast furnace slag.

5. The method according to claim 1, wherein the prepuff particles comprise one or more polymers selected from the group consisting of homopolymers of vinyl aromatic monomers; copolymers of at least one vinyl aromatic monomer with one or more of divinylbenzene, conjugated dienes, alkyl methacrylates, alkyl acrylates, acrylonitrile, and/or maleic anhydride; polyolefins; polycarbonates; polyesters; polyamides; natural rubbers; synthetic rubbers; and combinations thereof.

6. The method according to claim 1, wherein the cement comprises one or more materials selected from the group consisting of Portland cements, gypsum cements, gypsum compositions, aluminous cements, magnesia cements, Type I cement, Type IA cement, Type II cement, Type IIA cement, Type III cement, Type IIIA cement, Type IV cement and Type V cement.

7. The method according to claim 1, wherein the concrete formulation comprises plasticizers and/or fibers.

8. The method according to claim 1, wherein the aggregate is selected from the group consisting of stone, gravel, glass, silica, expanded slate, clay; pumice, perlite, vermiculite, scoria, diatomite, expanded shale, expanded clay, expanded slag, pelletized aggregate, tuff, macrolite, slate, expanded blast furnace slag, coal cinders, and combinations thereof.

9. The method according to claim 1, wherein the concrete formulation has a density of from about 40 to about 145 lb./ft³.

10. The method according to claim 1, wherein the concrete formulation comprises:
8-20 volume percent cement,
11-50 volume percent fine aggregate,
9-40 volume percent coarse aggregate, and
7-30 volume percent water;
wherein the slump value of the concrete formulation measured according to ASTM C 143 is from 2 to 8 inches; and wherein after the concrete formulation has cured and hardened for 28 days, has a compressive strength of at least 1400 psi as tested according to ASTM C39.

11. The method according to claim 1, wherein the concrete formulation comprises:
10-50 volume percent cement,
10-50 volume percent fine aggregate,
5-35 volume percent coarse aggregate, and
10-30 volume percent water;
wherein the slump flow determined according to ASTM C 172 is not more than 28 inches; and wherein after the concrete formulation has cured and hardened for 28 days, has a compressive strength of at least 2500 psi as tested according to ASTM C39.

12. The method according to claim 10, wherein the cement, water, fine aggregates, course aggregates, water and prepuff particles are combined and mixed using one or more pieces of mixing equipment selected from the group consisting of a concrete mixing truck, a pan style mixer, and a drum style mixer.

13. The method according to claim 11, wherein the concrete formulation is a precast concrete composition and is poured into a mold or cast of a required shape and allowed to cure and harden before being taken out and put into a desired position.

14. The method according to claim 11, wherein the concrete formulation is cast around already tensioned tendons.

15. The method according to claim 11, wherein the concrete formulation is placed in a form that includes tendons and compression is applied to the tendons after the placing, curing and hardening steps.

16. A road bed comprising a concrete formulation made according to the method of claim 1.

17. The method according to claim 1, wherein the prepuff particles are present in the concrete formulation at a level of from 12 to 40 volume percent.

18. The method according to claim 1, wherein the water to cementitious ratio of from 0.25 to 0.45.

19. (canceled)

20. The method according to claim 1, wherein the concrete formulation comprises a high range water reducer selected from the group consisting of lignosulfonates, sodium naphthalene sulfonate formaldehyde condensates, sulfonated melamine-formaldehyde resins, sulfonated vinylcopolymers, urea resins, and salts of hydroxy- or polyhydroxy-carboxylic acids, and combinations thereof

21. (canceled)

22. A concrete composition comprising
8-20 volume percent cement,
11-50 volume percent fine aggregate,
9-40 volume percent coarse aggregate,
7-30 volume percent water, and
6 to 40 volume percent of prepuff particles,
wherein the water to cementitious w/w ratio is from 0.25 to 0.6;
wherein the prepuff particles have an average particle diameter of from 0.2 mm to 3 mm, a bulk density of from 0.015 g/cc to 0.35 g/cc, an aspect ratio of from 1 to 3, and a smooth continuous outer surface;
wherein the cured and hardened concrete composition has a relative dynamic modulus (RDM) of at least 70% determined according to Procedure A of ASTM C666 (2003); and
wherein after the sure and hardened concrete composition has a 28 day compressive strength of at least 1400 psi as tested according to ASTM C39.

23. The composition according to claim 20 comprising 1-50 volume percent of fly ash having an LOI determined according to ASTM C 618 of greater than 6%.

24. A concrete composition comprising
10-50 volume percent cement,
10-50 volume percent fine aggregate,
5-35 volume percent coarse aggregate, and
10-30 volume percent water; and
6 to 40 volume percent of prepuff particles,
wherein the water to cementitious ratio is from 0.25 to 0.6;
wherein the prepuff particles have an average particle diameter of from 0.2 mm to 3 mm, a bulk density of from 0.015 g/cc to 0.35 g/cc, an aspect ratio of from 1 to 3, and a smooth continuous outer surface;
wherein the slump flow determined according to ASTM C 172 is not more than 26 inches;
wherein the cured and hardened concrete composition has a relative dynamic modulus (RDM) of at least 70% determined according to Procedure A of ASTM C666 (2003); and
wherein after the sure and hardened concrete composition has a 28 day compressive strength of at least 2500 psi as tested according to ASTM C39.

25. A structure comprising the concrete composition according to claim 20, wherein the structure is selected from the group consisting of a party wall, an ICF, a SIP, a bird bath, a bench, a shingle, siding, drywall, cement board, a decorative pillar, an archway for a building, a counter top, an in-floor radiant heating system, a floor, a tilt-up wall, a sandwich wall panel, a stucco coating, an arresting wall, a Jersey Barrier, a sound barrier, a wall, a retaining wall, a runway arresting systems, a runaway truck ramp, a road bed and a bridge deck.
